(19) United States
(12) Patent Application Publication
(10) Pub. No.: US 2006/0040165 A1
(43) Pub. Date: Feb. 23, 2006

(54) Fuel cell separator, fuel cell stack, fuel cell vehicle, and method of manufacturing fuel cell separator

(75) Inventors: Noriko Uchiyama, Miura-shi (JP); Nobutaka Chiba, Yokohama-shi (JP); Makoto Kano, Yokohama-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/220,982

(22) Filed: Sep. 8, 2005

Related U.S. Application Data
(63) Continuation-in-part of application No. 11/071,286, filed on Mar. 4, 2005.

(30) Foreign Application Priority Data
Mar. 11, 2004 (JP) 2004-069488
Sep. 8, 2004 (JP) 2004-260973
Sep. 29, 2004 (JP) 2004-283573
Oct. 6, 2004 (JP) 2004-293691
Mar. 9, 2005 (JP) 2005-066065

(51) Int. Cl. H01M 8/02; B32B 15/04; B05D 5/12

(52) U.S. Cl. 429/34; 428/469; 427/115; 427/126.1; 429/38

(57) ABSTRACT

A fuel cell separator of the present invention includes: a base material which is made of transition metal or an alloy of transition metal and has a path for fuel or an oxidant; and a nitride layer which is provided from a surface of the base material towards an inside thereof, contacts a single cell of a fuel cell, and has a cubic crystal structure. The fuel cell separator has excellent corrosion resistance in a strong acid atmosphere and low contact resistance with a carbon paper that configures a gas diffusion layer.

### BACKGROUND OF THE INVENTION

1. Field of the Invention

The present invention relates to a fuel cell separator, a fuel cell stack, a fuel cell vehicle, and a method of manufacturing the fuel cell separator, and particularly to a polymer electrolyte fuel cell separator formed of stainless steel.

2. Description of the Related Art

From a viewpoint of the protection of global environment, it has been examined to drive a vehicle by using a motor actuated by a fuel cell instead of an internal combustion engine. Fuel cells do not require fossil fuel, consumption of which raises a problem of exhaustion of natural resources, and therefore do not generate exhaust gas or the like. Fuel cells also have excellent characteristics in that they cause little noise and can realize higher energy recovery efficiency than other energy engines.

Fuel cells are categorized into polymer electrolyte fuel cells, phosphoric acid fuel cells, molten carbonate fuel cells, solid oxide fuel cells, and the like depending on the types of electrolyte used. Of these types of fuel cells, a polymer electrolyte fuel cell uses a polymer electrolyte membrane, which contains a proton exchange group within a molecule, as electrolyte, and utilizes the membrane's function as a proton-conductive electrolyte which is obtained once the membrane is saturated with water. A polymer electrolyte fuel cell operates at relatively low temperature and has high electrical efficiency. In addition, since a polymer electrolyte fuel cell is small and light in weigh with associated equipment, it is expected to be used for various purposes such as for mounting on an electric vehicle.

In order to mount polymer electrolyte fuel cells on a vehicle, they should be formed into a fuel cell stack. A fuel cell stack is configured by stacking a plurality of single cells, each serving as a base unit, sandwiching both sides of the cells with end flanges and then holding and pressing the cells by using fastening bolts so that the cells are integrated with each other. Each single cell is configured by a polymer electrolyte membrane, as well as an anode (a hydrogen electrode) and a cathode (an oxygen electrode) which are joined onto both sides of the polymer electrolyte membrane.

FIG. 15 shows a configuration of a single cell which forms a fuel cell stack. As shown in FIG. 15, a single cell 80 is made of a membrane electrode assembly formed by joining an oxygen electrode 82 and a hydrogen electrode 83 onto both sides of a polymer electrolyte membrane 81 and integrating them together. Both the oxygen electrode 82 and the hydrogen electrode 83 have a two-layer construction including a reaction membrane 84 and a gas diffusion layer 85, and the reaction membrane 84 is in contact with the polymer electrolyte membrane 81. An oxygen electrode side separator 86 and a hydrogen electrode side separator 87 are placed on the oxygen electrode 82 and the hydrogen electrode 83, respectively, for stacking. An oxygen gas flow pass, a hydrogen gas flow pass, and a cooling water flow pass are formed by the oxygen electrode side separator 86 and the hydrogen electrode side separator 87.

The single cell 80 having the above construction is manufactured as follows; the oxygen electrode 82 and the hydrogen electrode 83 are located on both sides of the polymer electrode membrane 81, respectively, and joined together usually by hot pressing, forming the membrane electrode assembly; and the separators 86 and 87 are placed on both sides of the membrane electrode assembly. Mixed gas of hydrogen, carbon dioxide, nitrogen, and moisture vapor is provided to the side of the hydrogen electrode 83 of a fuel cell configured by the above single cells 80, and air and moisture vapor are supplied to the side of the oxygen electrode 82 of the same. Then, electrochemical reactions occur mainly on the contact surfaces between the polymer electrolyte membrane 81 and the reaction membranes 84. This reaction is described more specifically below.

Once oxygen gas and hydrogen gas are supplied respectively to the oxygen gas flow pass and the hydrogen gas flow pass in the single cell 80 having the foregoing construction, the oxygen gas and hydrogen gas are supplied to the reaction membranes 84 through each gas diffusion layer 85, and the following reactions occur in each reaction membrane 84.
Hydrogen electrode side: H₂→2H⁺+2e⁻ (Formula 1)
Oxygen electrode side: (½)O₂+2H⁺+2e⁻→H₂O (Formula 2)

Once hydrogen gas is supplied to the hydrogen electrode 83, the reaction of Formula 1 progresses and H⁺ and e⁻ are produced. H⁺ moves within the polymer electrode membrane 81, which contains water, and flows towards the oxygen electrode 82, and e⁻ flows from the hydrogen electrode 83 to the oxygen electrode 82 through a load 48. On the side of the oxygen electrode 82, H⁺, 2e⁻, and the supplied oxygen gas progresses the reaction of Formula 2, thus generating electricity.

As described earlier, fuel cell separators used for a fuel cell stack have a function of electrically connecting single cells. Therefore, fuel cell separators are required to have good electric conductivity and low contact resistance with other components such as gas diffusion layers, and the like.

Further, a polymer electrolyte membrane is formed of polymer having a number of sulfonic acid groups and has proton conductivity because of sulfonic acid groups that accelerate movements of protons in a wet state. Further, as a polymer electrolyte membrane has strong acidity, a fuel cell separator is required to be corrosion resistant at acidity of pH 2 to 3. Moreover, temperature of each gas supplied to a fuel cell is as high as 80 to 90 degrees centigrade, so H⁺ is generated in the hydrogen electrode as stated earlier, and the oxygen electrode is in an oxidizing atmosphere where potential of about 0.6 to 1 V vs SHE (standard hydrogen electrode) is applied. Therefore, similarly to oxygen electrode and hydrogen electrode, a fuel cell separator needs to have sufficient corrosion resistance to endure a strong acid atmosphere. Here, a level of corrosion resistance required here is a level of durability with which electric conductivity can be maintained even in an oxidizing atmosphere at strong acidity. Measurement of the corrosion resistance has to be carried out in an environment where power generation characteristics of an electrolyte membrane are deteriorated. This environment is realized by allowing cations to be transferred to humidifying water or water generated by the reaction represented by Formula 1 so that the cations bond with sulfonic acid groups, original pathways of protons, and then occupy sulfonic acid groups.

There has been an attempt to use stainless steel or a titanium material such as commercial pure titanium for the fuel cell separators as they have good electric conductivity and high corrosion resistance. Stainless steel has a closely-packed passive state film of oxide, hydroxide or hydrate thereof and the like containing chromium as its main metallic element, formed on the surface. As with stainless steel, titanium has a closely-packed passive state film of titanium oxide, titanium hydroxide or hydrate thereof, formed on the surface. Therefore, stainless steel and titanium have good corrosion resistance.

However, this passive state film causes contact resistant with a carbon paper that is normally used as a gas diffusion layer. With regard to excessive voltage due to resistance polarization within a stationary type fuel cell, exhaust heat is recovered by cogeneration or the like, so heat efficiency is improved as a whole. However, as for a fuel cell for use in a vehicle, contact resistance-based heat loss has to be distributed to outside by a radiator through cooling water, which means that if contact resistance goes up electrical efficiency is reduced. Moreover, the decrease in electric efficiency is an equivalent to an increase in heat, and there will therefore be a need for providing a larger cooling system. Accordingly, a reduction in contact resistance is a key issue to be resolved.

In a fuel cell, a theoretical voltage per single cell is 1.23 V, but an actual voltage extracted is reduced due to reaction polarization, gas diffusion polarization and resistance polarization, and the larger a current to be extracted, the lower the voltage becomes. Moreover, since higher power density per unit volume and weight are demanded, a fuel cell for vehicle use is used at a higher current density, for example, a current density of 1 A/cm², than a stationary type fuel cell. It is considered that, when a current density is 1 A/cm², an efficiency decrease due to contact resistance between a separator and a carbon paper can be suppressed if the contact resistance is 40 mΩ·cm² or lower.

For this purpose, one kind of press-molded fuel cell separators made of stainless steel has been proposed. In this fuel cell separator, a gold-plated layer is formed directly on a surface which comes into contact with an electrode. (See Japanese Patent Laid-Open Publication No. H10-228914.) There is another proposed fuel cell in which, after stainless steel is formed into the shape of the fuel cell separator, a passive state film on a surface which comes into contact with other member and produces contact resistance is removed, and then the surface is coated with noble metal or a noble metal alloy (See Japanese Patent Laid-Open Publication No. 2001-6713.)

### SUMMARY OF THE INVENTION

However, plating or coating the surface of a fuel cell separator with noble metal like the above-mentioned conventional techniques requires costs for such materials.

The present invention has been accomplished focusing on the above-mentioned problems of the conventional techniques. An object of the present invention is to provide a fuel cell separator which achieves low contact resistance produced between the separator and an electrode, excellent corrosion resistance, and low cost, as well as a fuel cell stack and a fuel cell vehicle on which the fuel cell stack is mounted.

The first aspect of the present invention provides a fuel cell separator comprising: a base material which comprises transition metal or an alloy of transition metal and has a path for fuel or an oxidant; and a nitride layer which is provided from a surface of the base material towards an inside thereof, contacts a single cell of a fuel cell, and comprises a cubic crystal structure.

The second aspect of the present invention provides a fuel cell stack comprising: a fuel cell separator comprising: a base material which comprises transition metal or an alloy of transition metal and has a path for fuel or an oxidant; and a nitride layer which is provided from a surface of the base material towards an inside thereof, contacts a single cell of a fuel cell, and comprises a cubic crystal structure.

The third aspect of the present invention provides a fuel cell vehicle, comprising: a fuel cell stack comprising a fuel cell separator comprising: a base material which comprises transition metal or an alloy of transition metal and has a path for fuel or an oxidant; and a nitride layer which is provided from a surface of the base material towards an inside thereof, contacts a single cell of a fuel cell, and comprises a cubic crystal structure.

The fourth aspect of the present invention provides a method of manufacturing a fuel cell separator comprising: preparing a base material which comprises transition metal or an alloy of transition metal and has a path for fuel or an oxidant; and nitriding a surface of the base material at temperature of 590 degrees centigrade or lower to form a nitride layer having a M₄N-type crystal structure where a nitrogen atom is located in an octahedral gap at a center of a unit cell of a face-centered cubic lattice formed of at least one kind of metal atom selected from the group consisting of iron, chromium, nickel and: molybdenum, on the surface of the base material.

### BRIEF DESCRIPTION OF THE DRAWINGS

The invention will now be described with reference to the accompanying drawings wherein;

FIG. 1 is an external perspective view of a fuel cell stack using fuel cell separators according to an embodiment of the present invention;

FIG. 2 is a developed view of the fuel cell stack using fell cell separators according to the embodiment of the present invention;

FIG. 3A is a perspective view of the fuel cell separator;

FIG. 3B is a cross-sectional view taken along the line IIIB-IIIB in FIG. 3A;

FIG. 3C is a cross-sectional view taken along the line IIIC-IIIC in FIG. 3B;

FIG. 4 is a schematic view of an M₄N-type crystal structure contained in transition metal nitride according to the embodiment of the present invention;

FIGS. 5 and 6 are schematic views of a nitriding apparatus used for manufacturing the fuel cell separator according to the embodiment of the present invention;

FIG. 7A is an external side view of an electric vehicle on which the fuel cell stack according to the embodiment of the present invention is mounted;

FIG. 7B is an external top view of the electric vehicle on which the fuel cell stack according to the embodiment of the present invention is mounted;

FIG. 8A is a schematic view explaining a method for measuring contact resistance of samples obtained in Examples;

FIG. 8B is a schematic view explaining an apparatus used for measurement of contact resistance;

FIG. 9 is a view showing X-ray diffraction patterns of samples obtained in Example 5 and Comparative Example 1;

FIG. 10A is a cross-sectional photography of the sample obtained in Example 5:

FIG. 10B is a cross-sectional photography of the sample obtained in Comparative Example 1;

FIG. 11 is a view showing a depth-direction atom profile of the sample obtained in Example 5 by scanning Auger electron spectrometry;

FIG. 12A is a view showing a relationship between a contact resistance value and nitrogen and oxygen contents at the depth of 3 to 4 nm from the outermost surface of a nitride layer;

FIG. 12B is a view showing a relationship between a contact resistance value and nitrogen and oxygen contents at the depth of 10 nm from the outermost surface of the nitride layer;

FIG. 12C is a view showing a relationship between a contact resistance value and nitrogen and oxygen contents at the depth of 100 nm from the outermost surface of the nitride layer;

FIG. 13 is a graph showing contact resistance values before and after electrolysis testing of the samples obtained in Examples 15 to 22 and Comparative Examples 8 toll;

FIG. 14A is a graph showing a relationship between a contact resistance value and nitrogen and oxygen contents at the depth of 3 to 4 nm from the outermost surface of the nitride layer;

FIG. 14B is a graph showing a relationship between a contact resistance value and a ratio of an oxygen content to a nitrogen content O/N at the depth of 3 to 4 nm from the outermost surface of the nitride layer; and

FIG. 15 is a cross-sectional view showing a structure of a single cell forming the fuel cell stack.

### DETAILED DESCRIPTION OF THE PREFERRED EMBODIMENTS

The fuel cell separator, the fuel cell stack, the fuel cell vehicle, and the method of manufacturing the fuel cell separator according to an embodiment of the present invention are detailed below using an example of the present invention being applied to a polymer electrolyte fuel cell.

(Fuel Cell Separator and Fuel Cell Stack)

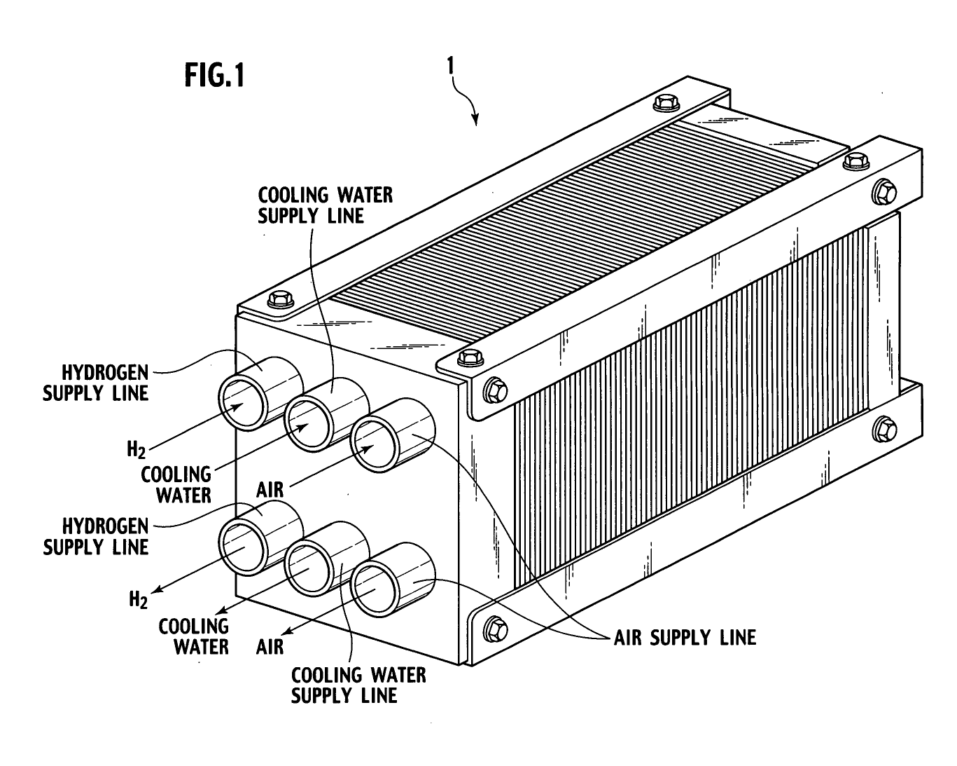

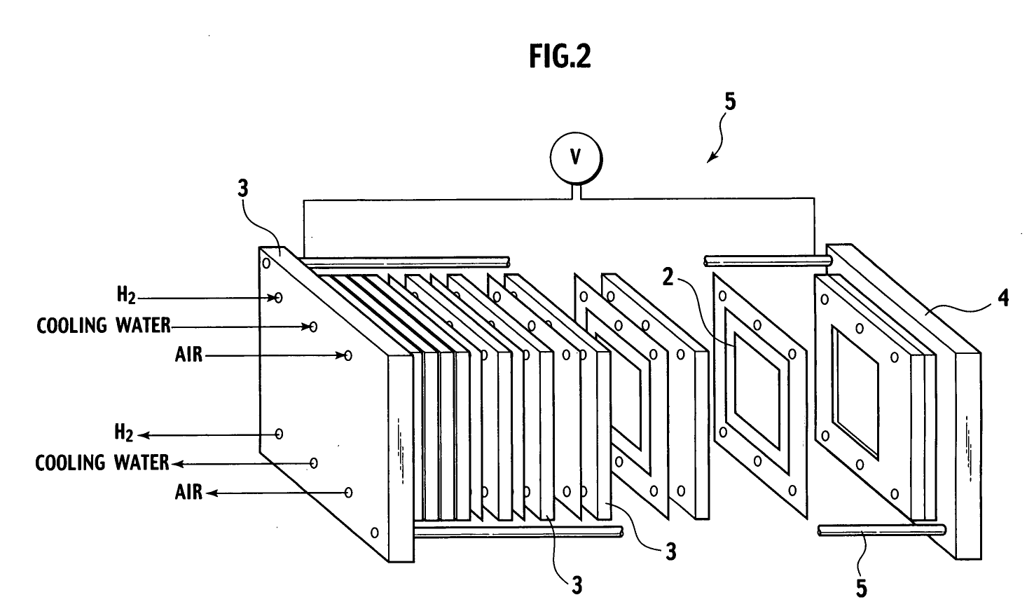

FIG. 1 shows an external view of a fuel cell stack in which fuel cell separators according to the embodiment of the present invention are used. FIG. 2 shows the details of the construction of the fuel cell stack 1 shown in FIG. 1.

As shown in FIG. 2, the fuel cell stack 1 is configured by stacking a plurality of single cells 2 and fuel cell separators 3 alternately. The single cell 2 is a basic unit of electricity generation by electrochemical reaction. Each single cell 2 is made of a membrane electrode assembly in which an oxygen electrode is provided on one side of a polymer electrolyte membrane and a fuel electrode is provided on the other side of the membrane. Moreover, the fuel cell separators 3 are located on both sides of the membrane electrode assembly so that an oxidant gas flow path and a fuel gas flow path are formed inside the stack. The polymer electrolyte membrane may be a perfluorocarbon polymer membrane having sulfonic acid groups (product name: Nafion1128 (registered trademark) manufactured by DuPont Kabushiki Gaisya) or the like. After the stacking of the single cells 2 and the fuel cell separators 3, end flanges 4 are put at both ends and the circumferences of the end flanges 4 are fastened with bolts 5, constructing the fuel cell stack 1. The fuel cell stack 1 is also provided with hydrogen supply lines which supply fuel gas containing hydrogen to each fuel cell 2, air supply lines which supply air as an oxidant, and cooling water supply lines which supply cooling water.

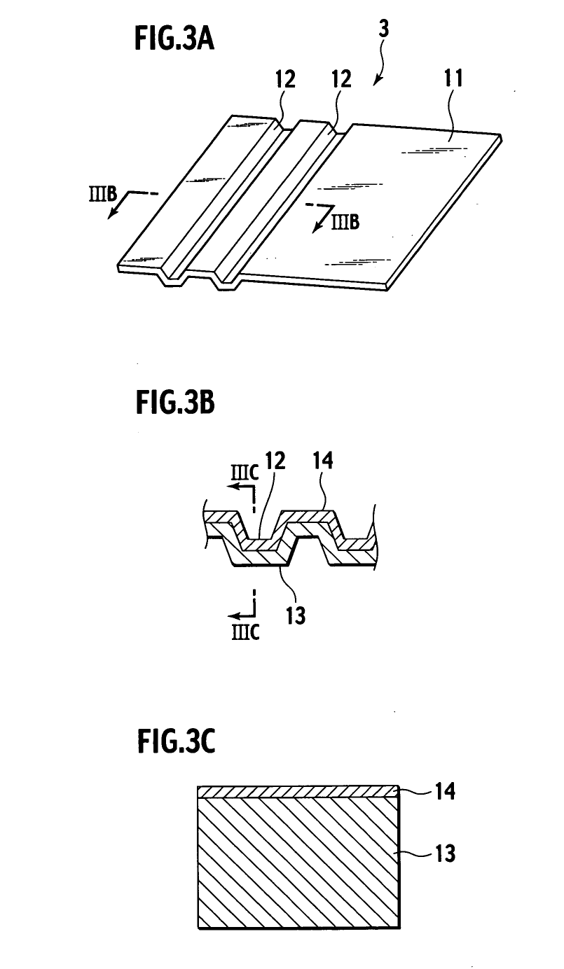

FIGS. 3A to 3C schematically show the fuel cell separator 3 shown in FIG. 2. As shown in FIG. 3A, a base material of the fuel cell separator 3, which is made from transition metal or an alloy thereof, is press-formed so that a passage 12 of fuel or oxidant, having a rectangular shape in cross section, is formed on the top surface 11 of the fuel cell separator 3. Further, a nitride layer 14 is extending along external surfaces of the base material 13 and the passage 12.

Transition metal or an alloy of transition metal is used for the base material of the fuel cell separator 3 in this embodiment, and a nitride layer having a cubic crystal structure is provided on the surface of the base material. Therefore, highly covalent bond is formed between transition metal atoms and nitrogen atoms in the nitride layer. In addition, metallic bond is formed between metal atoms. Therefore, the fuel cell separator with excellent electricity conductivity can be obtained. Furthermore, since the nitride layer having a cubic crystal structure is chemically stable even in a strong acid atmosphere at pH 2 to 3 usually used for a fuel cell, the fuel cell separator has good corrosion resistance. This realizes a fuel cell separator with low contact resistance between the fuel cell separator and carbon paper, and constantly high electricity conductivity even in a strong acid atmosphere. Further, since contact resistance can be maintained low without performing direct gold plating onto a contact surface with an electrode, cost reduction can be achieved.

Further, it is preferred that an atom ratio of chromium (Cr) to iron (Fe) Cr/Fe contained in the nitride layer be lower than that of Cr to Fe contained in the base material. Where the atom ratio of Cr to Fe in the nitride layer is higher than that of Cr to Fe in the base material, nitrogen is bonded to Cr in the base material, and primarily, Cr-based nitride having a NaCl-type crystal structure such as CrN is deposited. Thus, a depletion layer of Cr is produced in the base material, causing lower corrosion resistance. On the other hand, where the atom ratio of Cr to Fe contained in the nitride layer is lower than that of Cr to Fe in the base material, Cr-based nitride is not deposited. Therefore, Cr, which is contained in the base material and effective for corrosion resistance, is not reduced and corrosion resistance of the fuel cell separator 3 is thus maintained even after nitriding thereof. As a result, corrosion resistance of the separator in a high acid atmosphere becomes even more excellent.

It is preferred that the base material is stainless steel containing at least one kind of metal element selected from the group consisting of iron (Fe), chromium (Cr), nickel (Ni) and molybdenum (Mo). Stainless steel containing such elements includes austenitic stainless steel, austenitic-ferritic stainless steel, and precipitation-hardening stainless steel. The most preferred among them as the base material is austenitic stainless steel. Austenitic stainless steel includes SUS304, SUS310S, SUS316L, SUS317J1, SUS317J2, SUS321, SUS329J1, SUS836 and the like.

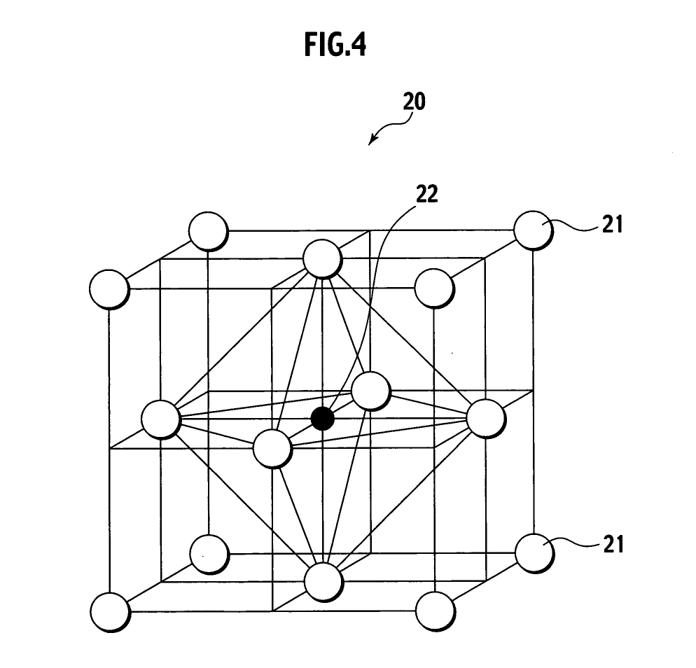

Specifically, the preferred cubic crystal structure of the nitride layer is an M₄N-type crystal structure where a nitrogen atom is located in the octahedral gap at the center of the unit cell of a face-centered cubic lattice formed of at least one kind of metal atom selected from the group consisting of Fe, Cr, Ni and Mo. The M₄N-type crystal structure is shown in FIG. 4. The M₄N-type crystal structure 20 is a structure where a nitrogen atom 22 is located in the octahedral gap of at the center of the unit cell of a face-centered cubic lattice formed of transition metal atoms 21 selected from Fe, Cr, Ni and Mo. In this M₄N-type crystal structure 20, M represents transition metal atoms 21 selected from Fr, Cr, Ni and Mo, and N represents the nitrogen atom 22. The nitrogen atom 22 occupies a fourth of the octahedral gap of the M₄N-type crystal structure 20. In other words, the M₄N-type crystal structure 20 is an interstitial solid solution in which the nitrogen atom 22 is interstitially present in the octahedral gap at the center of the unit cell of a face-centered cubic lattice formed of transition metal atoms 22. When expressed in a space lattice of in a cubic crystal, the nitrogen atom 22 is located in a lattice coordinate (1/2, 1/2, 1/2) of each unit cell. The M₄N-type crystal structure realizes strong covalent bond between transition metal atoms 21 and the nitrogen atom 22 while maintaining metallic bond among the transition metal atoms 21.

Moreover, in this M₄N-type crystal structure 20, the transition metal atoms 21 are preferably mainly Fe but can include an alloy obtained by partially substituting atoms of other kind of transitional metal such as Cr, Ni or Mo for Fe. It is also preferred that the transition metal atoms 21 constructing the M₄N-type crystal structure be in irregular arrangement. With an irregular arrangement, partial molar free energy of each transition metal atom is reduced, thus reducing an activity of each transition metal atom. Accordingly, reactivity within the nitride layer 14 to oxidation of each transition metal atom is also reduced, and the nitride layer 14 thus stays chemically stable even in an oxidative environment within a fuel cell. Therefore, durability of separator 3 is improved while maintaining low contact resistance between the separator 3 and an electrode such as carbon paper. Furthermore, since contact resistance is maintained low without forming a noble metal plating layer on the surface of the separator 3 which comes into contact with an electrode, cost reduction is achieved. It is also preferred that the transition metal atoms 21 be in irregular arrangement, i.e. no regularity is seen in partial substitution of Cr or the like for Fe, so that mixing entropy is increased. Then, partial molar free energy of each transition metal atom is reduced or an activity of each transition metal atom is lower than a value estimated based upon Raoult's law.

In this M₄N-type crystal structure 20, as described earlier, where the atom ratio of Cr to Fe in the nitride layer is higher than that in the base material, nitrogen contained in the nitride layer is bonded to Cr in the nitride layer, and Cr-based nitride such as CrN, in other words, the NaCl-type nitride compound, becomes a main component. As a result, corrosion resistance of the nitride layer is lowered. Hence, it is preferred that the transition metal atoms 21 are mainly Fe. The nitride layer with this type of crystal structure is considered to be nitride having the fcc or fct structure with high-density transition and twin crystal, high hardness of 1000 HV, and supersaturated nitrogen solid solution (Yasumaru and Kamachi, Journal of Japan Institute of Metals, Vol. 50, pp. 362-368, 1986). In such nitride layer, the closer to the surface, the higher the concentration of nitrogen becomes. In addition, since CrN does not become a main component, Cr, which is effective for corrosion resistance, is not reduced and corrosion resistance is thus maintained even after nitriding. Where the nitride layer has the crystal structure where an N atom is located in the octahedral gap at the center of the unit cell of a face-centered cubic lattice formed of at least one or more kinds of metal atoms selected from a group of Fe, Cr, Ni and Mo, corrosion resistance of the separator in a strong acid atmosphere of pH 2 to 3 can be even more excellent. In addition, contact resistance between the separator and a carbon paper can be lowered.

It is preferred that the thickness ratio of the nitride layer to the base material ranges from 1/2000 to 1/10. To be more specific, where the thickness of the base material is 0.1 mm, it is preferred that the nitride layer is formed on the surface of the base material to have a thickness ranging from 0.05 to 10 μm. In this case, the separator can have excellent corrosion resistance in a strong acid atmosphere and low contact resistance with a carbon paper that configures a gas diffusion layer. Where the thickness of the nitride layer is smaller than 0.05 μm, a crack may occur between the nitride layer and the base material, and bonding strength between the nitride layer and the base material becomes insufficient. Therefore, after a long period of use, the nitride layer is easily peeled off from the interface with the base material, causing a difficulty in obtaining sufficient corrosion resistance. Where the thickness of the nitride layer is over 10 μm, strain within the nitride layer becomes excessive as the thickness of the nitride layer increases, thus causing a crack in the nitride layer. Due to this, pitting corrosion easily occurs in the fuel cell separator, making it difficult to improve corrosion resistance.

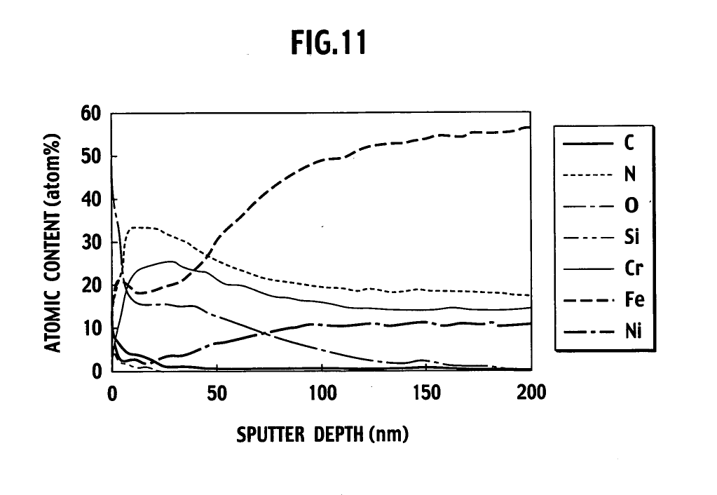

Moreover, it is preferred that a nitrogen content and an oxygen content at the depth of 3 to 4 nm from the outermost surface of the nitride layer be 5 atom % or higher and 50 atom % or lower, respectively. In other words, as shown in FIG. 11, in an area to a sputter depth of 3 to 4 nm, it is preferred that the nitrogen content be 5 atom % or higher and the oxygen content be 50 atom % or lower. Here, the outermost surface indicates an atom layer on the outermost portion of the nitride layer. Once the coverage of oxygen molecules adsorbed on the surface of metal increases, clear bonding of a metal atom and an oxygen atom is formed. This is oxidization of a metal atom. Such oxidization of a metal surface is first caused by oxidization of the first atom layer on the outermost portion. Once oxidization of the first atom layer ends, oxygen absorbed onto the first atom layer receives a free electron within the metal by tunnel effect and oxygen becomes an anion. Due to a strong local electrical field caused by the anion, a metal ion is drawn from the inside of the metal to the surface thereof, and the metal ion drawn out is bonded to an oxygen atom, thus producing the second oxide film. The reactions like this happen one after another, increasing the thickness of the oxide film. Accordingly, where the oxygen content within the nitride layer is more than 50 atom %, an electric-insulating oxide film is formed easily. On the contrary, where a compound of a metal atom and nitrogen is made with higher chemical potential of N within the nitride layer and even lower activity of the metal atom, free energy of the metal atom is decreased. This can lower reactivity of the metal atom to oxidization, and the metal atom is thus chemically stabilized. Therefore, an oxygen atom has no free electron to receive and no longer oxidizes the metal atom, thus suppressing the growth of an oxide film. Accordingly, where nitrogen content and oxygen content at the depth of 3 to 4 nm from the outermost surface of the nitride layer are 5 atom % or higher and 50 atom % or lower, respectively, it is possible to suppress the growth of an oxide film and lower contact resistance between a separator and a carbon paper. In addition, it becomes possible to obtain a fuel cell separator with excellent corrosion resistance in a strong acid atmosphere. Further, it is preferred that the nitrogen content and oxygen content at the depth of 3 to 4 nm from the outermost surface of the nitride layer be 9 atom % or higher and 43 atom % or lower, respectively. Furthermore, it is more preferred that the nitrogen content and oxygen content at the depth of 3 to 4 nm from the outermost surface of the nitride layer be 10 atom % or higher and 35 atom % or lower, respectively. In this case, contact resistance can be lowered even further.

It is also more preferred that a ratio of the oxygen content to the nitrogen content O/N at the depth of 3 to 4 nm from the outermost surface of the nitride layer be 10.0 or lower. In this case, the nitrogen content and oxygen content satisfy the requirement that they are to be 5 atom % or higher and 50 atom % or lower, respectively. Moreover, it is possible to obtain excellent corrosion resistance in a strong acid atmosphere, and contact resistance between the separator and a carbon paper can be lowered. If the nitrogen and oxygen contents deviate from the above range, contact resistance will be high because a passive state oxide film will be formed on the surface of the base material, and the separator will thus have poor electric conductivity. Further, it is preferred that O/N be 4.8 or lower. Furthermore, it is more preferred that O/N be 3.5 or lower.

It is also preferred that a nitrogen content and an oxygen content at the depth of 10 nm from the outermost surface of the nitride layer be 10 atom % or higher and 30 atom % or lower, respectively. In this case, the separator can have excellent corrosion resistance in a strong acid atmosphere and a lower contact resistance with a carbon paper. Where the nitrogen and oxygen contents deviate from the above range, contact resistance generated between the separator and an electrode increases. Therefore, a value of contact resistance of each single cell, which configures the fuel cell stack, exceeds 40 mΩ cm², thus deteriorating power generation capability. Further, it is preferable that the nitrogen content and oxygen content at the depth of 10 nm from the outermost surface of the nitride layer be 15 atom % or higher and 26 atom % or lower, respectively. Furthermore it is more preferable that the nitrogen content and oxygen content at the depth of 10 nm from the outermost surface of the nitride layer be 18 atom % or higher and 22 atom % or lower, respectively. In this case, contact resistance can be lowered even further.

Furthermore, it is preferred that a nitrogen content and an oxygen content in an area between 100 nm to 200 nm from the outermost surface of the nitride layer be 16 atom % or higher and 21 atom % or lower, respectively. In this case, contact resistance can be lowered even further.

As described above, since the above-described construction is adopted, the fuel cell separator according to the embodiment of the present invention has excellent corrosion resistance. This separator can also be low in cost and high in productivity and at the same time have low contact resistance with a neighboring component such as a gas diffusion layer and a good power generation capability of a fuel cell. Moreover, the fuel cell stack according to the embodiment of the present invention uses the fuel cell separators according to the embodiment of the present invention. Therefore, the fuel cell stack can maintain high electrical efficiency without losing a power generation capability and realize reduction of size and cost.

(Method of Manufacturing Fuel Cell Separator)

Next, an embodiment of a method of manufacturing the fuel cell separator of the above embodiment of the present invention is described. The method of manufacturing this fuel cell separator is characterized in that a base material made of stainless steel is nitrided at temperature of 590° C. or lower to form a nitride layer on the surface of the base material, the nitride layer having the crystal structure where an N atom is located in the octahedral gap at the center of the unit cell of a face-centered cubic lattice formed of at least one or more kinds of metal atoms selected from a group of Fe, Cr, Ni and Mo.

Once a surface of stainless steel is nitrided at high temperature, nitrogen is bonded to Cr contained in the base material and nitride having the NaCl-type crystal structure such as CrN is mainly deposited. Therefore, corrosion resistance of the fuel cell separator is lowered. On the other hand, where nitriding is performed at temperature of 590° C. or lower, what is mainly formed on the surface of the base material is not a nitride compound having the NaCl-type crystal structure such as CrN, but that having a crystal structure where an N atom is located in the octahedral gap at the center of the unit cell of a face-centered cubic lattice formed of at least one or more kinds of metal atoms selected from a group of Fe, Cr, Ni and Mo. Amongst nitride layers, the one with this crystal structure has particularly high corrosion resistance. Therefore, nitriding at low temperature of 590° C. or lower can improve corrosion resistance of a fuel cell separator. Further, contact resistance between the separator and a neighboring component such as a gas diffusion layer can also be lowered, thus maintaining electrical efficiency of the fuel cell and enabling the fuel cell separator having highly reliable durability to be obtained at low cost. Further, it is preferred that nitriding is performed at temperature of 570° C. or lower. Furthermore, it is more preferred that nitriding is performed at temperature of 500° C. or lower. Where nitriding is carried out at temperature of 500° C. or lower, contact resistance is lowered further and a fuel cell separator with improved corrosion resistance can be obtained.

Where nitriding temperature is lower than 350° C., an extended period of time is required for nitriding to obtain a nitride layer having the aforementioned crystal structure, which reduces productivity. Therefore, it is preferred that nitriding is performed at temperature ranging from 350 to 590° C., more preferably from 350 to 500° C.

Furthermore, it is preferred that nitriding be plasma nitriding (ion nitriding). Gas nitriding, gas nitrocarburizing, salt bath method, and plasma nitriding can be applied to the nitriding. Where gas nitrocarburizing is used, oxygen partial pressure during nitriding is high, and therefore an oxygen content within a nitride layer will be high. Amongst the above nitriding methods, plasma nitriding is performed as follows: nitrogen gas is ionized by glow discharge produced by application of a direct current voltage while an object to be nitrided is set as a cathode; and the ionized nitrogen collides at a very fast with the surface of the object to be nitrided, thus the object is nitrided. Therefore, plasma nitriding can nitride the surface of stainless steel, the object to be nitrated, while easily removing a passive state film on the surface the stainless steel by sputtering effect of ion impacts, and is thus suitable for the nitriding of stainless steel. In addition, with plasma nitriding, nitrogen ion is penetrated through the base material by a non-equilibrium reaction. Therefore, the foregoing crystal structure can be obtained with ease and in a short period of time, whereby corrosion resistance is improved.

The nitride layer in the separator of the present invention is not prepared by coating the base material with nitride but by introducing nitrogen atoms into the surface of the base material so that transition metal atoms in the surface of the base material bond with the introduced nitrogen. Therefore, as described later, the separator has characteristics in that the nitrogen density becomes lower with distance from the surface of the base material, in other words, the nitride layer has a density gradient of nitrogen from the surface thereof towards the inside. By forming the nitride layer without coating the base material with nitride like the present invention, an increase in thickness of the separator can be avoided. Further, material costs for the nitride layer can also be reduced, enabling the nitride layer to be prepared at low cost.

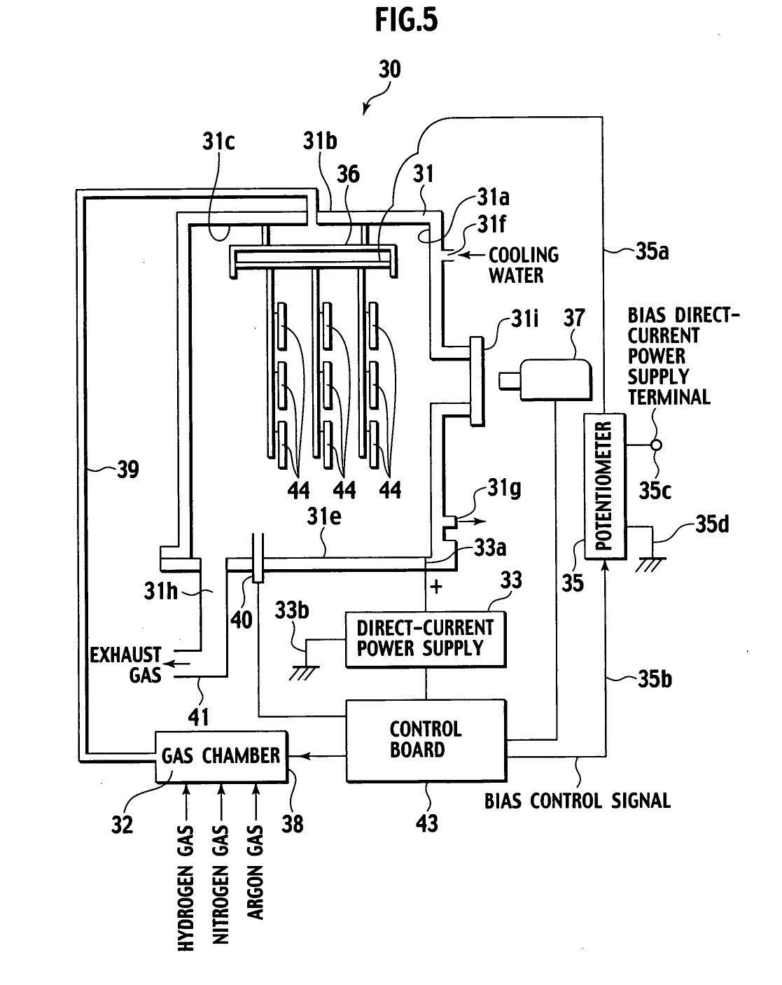

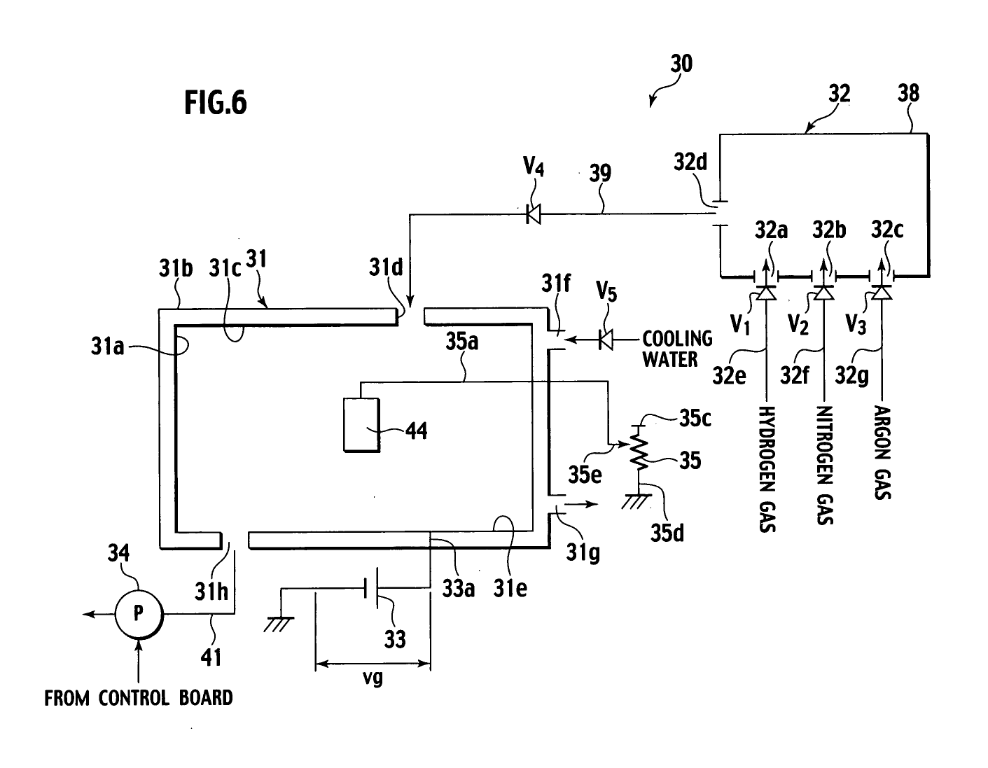

FIGS. 5 and 6 show a nitriding apparatus 30 used for manufacturing the fuel cell separator according to the embodiment of the present invention. The nitriding apparatus 30 includes a nitriding batch furnace 31, a gas supply apparatus 32 supplying gas to the nitriding furnace 31, plasma electrodes 33a and 33b generating plasma within the nitriding furnace 31, a direct-current power supply 33 supplying direct currents to the electrodes 33a and 33b, a pump 34 discharging gas from the nitriding furnace 31, and a temperature sensor 37 detecting temperature within the nitriding furnace 31. The nitriding furnace 31 has an inner wall 31a and an outer wall 31b. The ceiling 31c of the inner wall 31a is provided with a stainless steel hunger 36 for hanging stainless steel foils 44 formed into a shape of fuel cell separator. The gas supply apparatus 32 has a gas chamber 38 and a gas supply path 39, and the gas chamber 38 is provided with openings 32a, 32b, 32c and 32d. The openings 32a, 32b and 32c communicate with a H₂ gas supply line 32e having a gas supply valves V1, a N₂ gas supply line 32f having a gas supply valve V2, an Ar gas supply line 32g having a gas supply valve V3, respectively. The gas supply apparatus 32 has the opening 32d communicating with one end of the gas supply path 39. The ceiling 31c of the nitriding furnace 31 has the opening 31d communicating with the other end of the gas supply path 39. The gas supply path 39 is provided with a gas supply valve V4. A pressure of gas within the nitriding furnace 31 is detected by a gas pressure sensor 40 provided at the bottom 31e of the nitriding furnace 31. The nitriding furnace 31 is also provided with a cooling water flow path (not shown). Cooling water flows into the cooling water flow path from an opening 31f provided on the outer wall 31b of the nitriding furnace 31 and flows out of the flow path through an opening 31g. The opening 31f is provided with a cooling water supply valve V5 for adjusting a flow rate of cooling water. The pump 34 is connected to a discharge pipe 41 communicating with an opening 31h provided at the bottom 31e. The temperature sensor 37 is set to the setting opening 31i provided on the outer wall 31b of the nitriding furnace 31.

In addition to the direct-current power supply 33 controlled by a control board 43 for glow discharge, a bias potentiometer 35 is provided in the nitriding apparatus 30. A positive electrode (plus electrode) 33a of the direct-current power supply 33 is connected to the inner wall 31a of the nitriding furnace 31, and a negative electrode (minus electrode) 33b is grounded. The potentiometer 35 divides a potential difference between a bias direct-current power supply terminal 35c and a ground circuit 35d within a range from 0V to a bias voltage using a movable contact 35e, and supplies a voltage thus obtained to each stainless steel foil 44 through a bias circuit 35a. The direct-current power supply 33 is turned on and off by control signals from the control board 43. The control board 43 supplies bias control signals to the potentiometer 45 through a bias control circuit 35b, and the movable contact 35e slides according to the control signals. Therefore, relative to the inner wall 31a, each stainless steel foil 44 has a voltage difference which is the sum of a voltage between terminals of the direct-current power supply 33 and a bias voltage supplied through the movable contact 35e. Note that the gas supply apparatus 32 and the gas pressure sensor 40 are also controlled by the control board 43.

For plasma nitriding, nitrogen gas and hydrogen gas are used. It is preferred that nitriding of a stainless steel material be performed at temperature between 400 and 500 degrees centigrade by applying a negative bias voltage to the stainless steel material in low-temperature non-equilibrium plasma obtained by electric discharge of nitrogen gas and hydrogen gas. With the plasma nitriding, a passive state film on the surface of the metal material is easily removed by a spattering effect of ion bombardment. Meanwhile, if nitriding is performed using a normal method such as gas nitriding or salt bath nitriding, oxidation occurs on the outermost layer on the order of a few to a few tens nm of the nitride layer and an insulating oxidant is thus formed, resulting in an increase in contact resistance between the separator and carbon paper usually used as a gas diffusion layer of a fuel cell. On the other hand, where nitriding is performed using a plasma nitriding method as described in the present invention, a nitriding reaction proceeds while removing oxygen on the surface of the metal material, enabling a low oxygen level on the outermost layer of the metal material after the nitriding. Moreover, a contact resistance value between the separator and carbon paper can be maintained low.

It is also preferred that conditions for the plasma nitriding be temperature of 400 to 500 degrees centigrade, processing time of 1 to 60 minutes, a gas mixing ratio of N₂:H₂=1:5 to 7:3, and a processing pressure of 3 to 7 Torr (=399 to 931 Pa). The nitriding processing time is set as above because, with processing time shorter than 1 minute, a nitride layer is not formed, and with processing time over 60 minutes, manufacturing costs rise steeply. Further, the gas-mixing ratio is set as above because, if a ratio of nitrogen within gas is reduced, the nitride layer cannot be formed. On the other hand, if a ratio of nitrogen is increased, hydrogen acting as a reducing agent is decreased, resulting in oxidation of the surface of the base material. By performing the plasma nitriding under the aforementioned conditions, the nitride layer having the M₄N-type crystal structure is formed on the surface of the base material.

Plasma CVD may also be used as a method of nitriding. With plasma CVD, a compound containing elements, which serve as a row material, is dissolved by plasma, causing a chemical reaction, and the abovementioned crystal structure is formed on the surface of a heated base material. In the case of the plasma CVD, nitriding is performed under a reduced pressure similarly to the plasma nitriding method. Thus, a nitride layer can be formed by dissolving elements in a gas form by plasma under a low-oxygen atmosphere so that the elements are ionized. Therefore, the surface of the base material can be turned into a nitride layer with low oxygen content and high nitrogen content. This provides an advantage in that contact resistance of the surface of the base material is maintained low.

With the method of manufacturing a fuel cell separator according to the embodiment of the present invention, it becomes possible to manufacture, with an easy operation, a fuel cell separator which realizes low contact resistance under an oxidizing environment, excellent corrosion resistance, and cost reduction.

(Fuel Cell Vehicle)

In this embodiment, a fuel cell electric vehicle powered by a fuel cell including the fuel cell stack manufactured in the foregoing method is described as an example of a fuel cell vehicle.

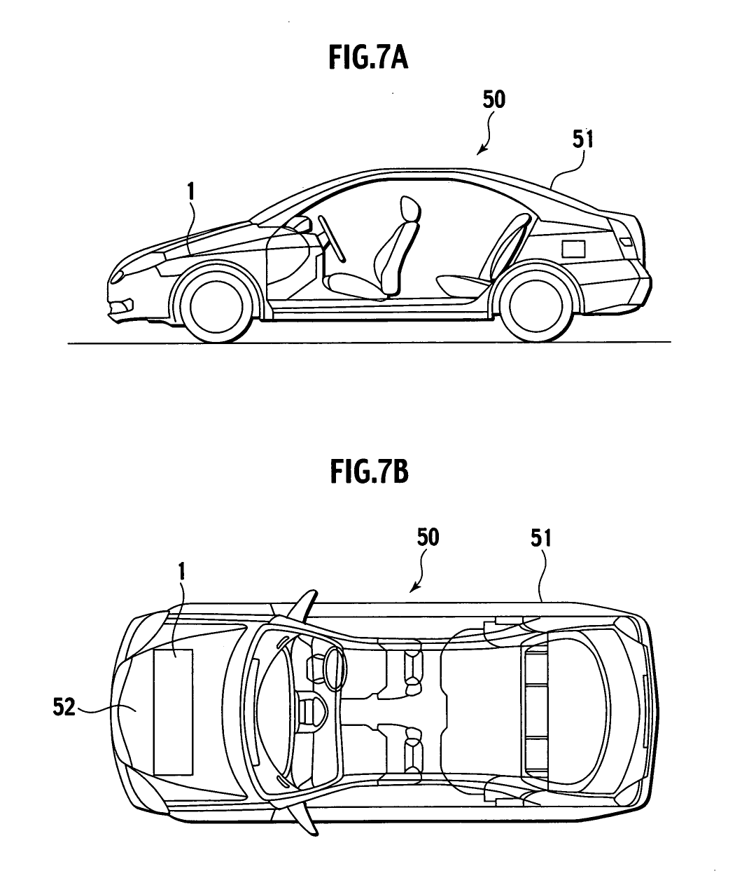

In FIGS. 7A and 7B show external views of the electric vehicle 50 on which the fuel cell stack is mounted. As shown in FIG. 7B, an engine compartment 52 is formed on the front side of a vehicle body 51. The engine compartment 52 is formed by combining and welding front side members and hood ridges on the right and left sides, as well as a dash lower member which connects the right and left hood ridges including the front side members to each other. In the electric vehicle according to the embodiment of the present invention, the fuel cell stack 1 is mounted within the engine compartment 52.

By mounting on the a vehicle the fuel cell stack in which the fuel cell separators according to the embodiment of the present invention are applied and which has a good power generation capability, an improvement of fuel efficiency of the fuel cell electric vehicle can be achieved. Moreover, according to the embodiment, by mounting the small-sized and light-weighted fuel cell stack on a vehicle, the vehicle weight can be reduced, thus saving fuel and delivering more mileage. Furthermore, according to the embodiment, by mounting the small fuel cell on a mobile unit such as a vehicle, the usable interior space of the vehicle becomes wider, securing design freedom.

The electric vehicle was described as an example of the fuel cell vehicle. However, the present invention is not only applied to such vehicle as an electric vehicle but also to engines of an aircraft and the like which require electric energy.

Examples 1 to 25 of fuel cell separators according to the embodiment of the present invention and Comparative Examples 1 to 13 are described below. Hereinafter, the depth of 3 to 4 nm from the outermost surface of the nitride layer is referred to as the “top surface of the nitride layer”.

<Preparation of Samples>

In Examples and Comparative Examples, 0.1-mm thick bright annealing (BA) materials of Japan Industrial Standards (JIS)-accredited austenitic stainless steel (SUS 304, SUS316, SUS 316L, and SUS310), a nickel alloy Inconel 600, and commercial pure titanium (JIS Type 1), all shown in Tables 1 to 3, were used. After degreasing of these materials, plasma nitriding using direct-current glow discharge or plasma CVD was performed on both sides of the materials. As for the plasma nitriding conditions, processing temperature was 350 to 700 degrees centigrade, processing time was 1 to 60 minutes, gas mixing ratios in Examples 1 to 10 were N₂:H₂=1:5 to 7:3, and a processing pressure was 3 to 7 Torr (=399 to 931 Pa) as shown in Tables 4 to 6. For conditions of the plasma CVD, processing temperature was 400 to 500 degrees centigrade, gas mixing ratios were N₂:H₂:NH₂=1:1:3, and a processing pressure was 1 Torr (=133 Pa). Note that no nitriding was performed in Comparative Examples 1 to 3, 8 to 10, and 12. Tables 1 to 3 show base materials and compositions of the base materials, and Tables 4 to 6 show methods and conditions for nitriding.

TABLE 1

| | | Composition of Base Material | | |
|---|---|---|---|---|
| | | | First Transition | Second Transition |
| | Base Material | | Metal Series | Metal Series |
| Ex. 1 | SUS304 | Fe—8Cr—18Ni | Fe, Cr, Ni | None |
| Ex. 2 | SUS316 | Fe—18Cr—12Ni—2Mo | Fe, Cr, Ni | Mo |
| Ex. 3 | SUS310 | Fe—25Cr—20Ni | Fe, Cr, Ni | None |
| Ex. 4 | SUS316 | Fe—18Cr—12Ni—2Mo | Fe, Cr, Ni | Mo |
| Ex. 5 | SUS316 | Fe—18Cr—12Ni—2Mo | Fe, Cr, Ni | Mo |
| Ex. 6 | SUS316 | Fe—18Cr—12Ni—2Mo | Fe, Cr, Ni | Mo |
| Ex. 7 | SUS316 | Fe—18Cr—12Ni—2Mo | Fe, Cr, Ni | Mo |
| Ex. 8 | SUS316 | Fe—18Cr—12Ni—2Mo | Fe, Cr, Ni | Mo |
| Ex. 9 | SUS316 | Fe—18Cr—12Ni—2Mo | Fe, Cr, Ni | Mo |
| Ex. 10 | SUS316 | Fe—18Cr—12Ni—2Mo | Fe, Cr, Ni | Mo |
| Ex. 11 | SUS316 | Fe—18Cr—12Ni—2Mo | Fe, Cr, Ni | Mo |
| Ex. 12 | SUS316 | Fe—18Cr—12Ni—2Mo | Fe, Cr, Ni | Mo |
| Ex. 13 | SUS316 | Fe—18Cr—12Ni—2Mo | Fe, Cr, Ni | Mo |
| Ex. 14 | SUS316 | Fe—18Cr—12Ni—2Mo | Fe, Cr, Ni | Mo |
| Com. Ex. 1 | SUS304 | Fe—8Cr—18Ni | Fe, Cr, Ni | None |
| Com. Ex. 2 | SUS316 | Fe—18Cr—12Ni—2Mo | Fe, Cr, Ni | Mo |
| Com. Ex. 3 | SUS310 | Fe—25Cr—20Ni | Fe, Cr, Ni | None |
| Com. Ex. 4 | SUS316 | Fe—18Cr—12Ni—2Mo | Fe, Cr, Ni | Mo |
| Com. Ex. 5 | SUS316 | Fe—18Cr—12Ni—2Mo | Fe, Cr, Ni | Mo |
| Com. Ex. 6 | SUS316 | Fe—18Cr—12Ni—2Mo | Fe, Cr, Ni | Mo |
| Com. Ex. 7 | SUS316 | Fe—18Cr—12Ni—2Mo | Fe, Cr, Ni | Mo |

TABLE 2

| | | Composition of Base Material | | |
|---|---|---|---|---|
| | | | First Transition | Second Transition |
| | Base Material | | Metal Series | Metal Series |
| Ex. 15 | SUS316 | Fe—18Cr—12Ni—2Mo | Fe, Cr, Ni | Mo |
| Ex. 16 | SUS304 | Fe—8Cr—18Ni | Fe, Cr, Ni | None |
| Ex. 17 | SUS310 | Fe—25Cr—20Ni | Fe, Cr, Ni | None |
| Ex. 18 | SUS316 | Fe—18Cr—12Ni—2Mo | Fe, Cr, Ni | Mo |
| Ex. 19 | SUS316 | Fe—18Cr—12Ni—2Mo | Fe, Cr, Ni | Mo |
| Ex. 20 | SUS316 | Fe—18Cr—12Ni—2Mo | Fe, Cr, Ni | Mo |
| Ex. 21 | INCONEL600 | 8Fe—15Cr—Ni | Fe, Cr, Ni | None |
| Ex. 22 | Ti | Ti | Ti | None |
| Com. Ex. 8 | SUS316 | Fe—18Cr—12Ni—2Mo | Fe, Cr, Ni | Mo |
| Com. Ex. 9 | INCONEL600 | 8Fe—15Cr—Ni | Fe, Cr, Ni | None |
| Com. Ex. 10 | Ti | Ti | Ti | None |
| Com. Ex. 11 | Al | Al | None | None |

TABLE 3

| | | Composition of Base Material | | |
|---|---|---|---|---|
| | Base | | First Transition | Second Transition |
| | Material | | Metal Series | Metal Series |
| Ex. 23 | SUS316L | Fe—18Cr—12Ni—2.5Mo— | Fe, Cr, Ni | Mo |
| | | Low C | | |
| Ex. 24 | SUS316L | Fe—18Cr—12Ni—2.5Mo— | Fe, Cr, Ni | Mo |
| | | Low C | | |
| Ex. 25 | SUS316L | Fe—18Cr—12Ni—2.5Mo— | Fe, Cr, Ni | Mo |
| | | Low C | | |
| Com. Ex. 12 | SUS313L | Fe—18Cr—12Ni—2.5Mo— | Fe, Cr, Ni | Mo |
| | | Low C | | |
| Com. Ex. 13 | SUS316L | Fe—18Cr—12Ni—2.5Mo— | Fe, Cr, Ni | Mo |
| | | Low C | | |

TABLE 4

| | | | | Gas | |
|---|---|---|---|---|---|
| | | | | Mixing | |
| | Nitriding | | Time | Ratio | Pressure |
| | Method | Temp.(C. °) | (minute) | (N₂:H₂) | (Torr) |
| Ex. 1 | Plasma | 430 | 5 | 1:5 | 7 |
| | Nitriding | | | | |
| Ex. 2 | Plasma | 430 | 5 | 1:5 | 7 |
| | Nitriding | | | | |
| Ex. 3 | Plasma | 430 | 5 | 1:5 | 7 |
| | Nitriding | | | | |
| Ex. 4 | Plasma | 400 | 30 | 1:5 | 7 |
| | Nitriding | | | | |
| Ex. 5 | Plasma | 400 | 20 | 1:5 | 7 |
| | Nitriding | | | | |
| Ex. 6 | Plasma | 450 | 3 | 1:5 | 7 |
| | Nitriding | | | | |
| Ex. 7 | Plasma | 500 | 1 | 1:5 | 7 |
| | Nitriding | | | | |
| Ex. 8 | Plasma | 380 | 10 | 1:5 | 7 |
| | Nitriding | | | | |
| Ex. 9 | Plasma | 380 | 5 | 1:5 | 7 |
| | Nitriding | | | | |
| Ex. 10 | Plasma | 400 | 45 | 1:5 | 7 |
| | Nitriding | | | | |
| Ex. 11 | Plasma | 400 | 60 | 1:1 | 7 |
| | Nitriding | | | | |
| Ex. 12 | Plasma | 550 | 10 | 1:1 | 7 |
| | Nitriding | | | | |
| Ex. 13 | Plasma | 570 | 10 | 1:1 | 7 |
| | Nitriding | | | | |
| Ex. 14 | Plasma | 590 | 10 | 1:1 | 7 |
| | Nitriding | | | | |
| Com. Ex. 1 | None | — | — | — | 7 |
| Com. Ex. 2 | None | — | — | — | 7 |
| Com. Ex. 3 | None | — | — | — | 7 |
| Com. Ex. 4 | Plasma | 550 | 5 | 1:1 | 7 |
| | Nitriding | | | | |
| Com. Ex. 5 | Plasma | 600 | 5 | 1:1 | 7 |
| | Nitriding | | | | |
| Com. Ex. 6 | Plasma | 700 | 5 | 1:1 | 7 |
| | Nitriding | | | | |
| Com. Ex. 7 | Plasma | 350 | 5 | 1:1 | 7 |
| | Nitriding | | | | |

TABLE 5

| | | | | Gas | |
|---|---|---|---|---|---|
| | | | | Mixing | |
| | Nitriding | | Time | Ratio | Pressure |
| | Method | Temp.(C. °) | (minute) | (N₂:H₂) | (Torr) |
| Ex. 15 | Plasma | 400 | 45 | N₂:H₂ = 1:1 | 4 |
| | Nitriding | | | | |
| Ex. 16 | Plasma | 450 | 30 | N₂:H₂ = 1:1 | 4 |
| | Nitriding | | | | |
| Ex. 17 | Plasma | 500 | 30 | N₂:H₂ = 1:1 | 4 |
| | Nitriding | | | | |
| Ex. 18 | Plasma | 570 | 30 | N₂:H₂ = 1:1 | 4 |
| | Nitriding | | | | |
| Ex. 19 | Plasma CVD | 400 | 30 | N₂:H₂:NH₃ = | 1 |
| | | | | 1:1:1 | |
| Ex. 20 | Plasma CVD | 500 | 30 | N₂:H₂:NH₃ = | 1 |
| | | | | 1:1:1 | |
| Ex. 21 | Plasma | 500 | 60 | N₂:H₂ = 1:1 | 4 |
| | Nitriding | | | | |
| Ex. 22 | Plasma | 500 | 60 | N₂:H₂ = 1:1 | 4 |
| | Nitriding | | | | |
| Com. | None | — | — | — | — |
| Ex. 8 | | | | | |
| Com. | None | — | — | — | — |
| Ex. 9 | | | | | |
| Com. | None | — | — | | — |
| Ex. 10 | | | | | |
| Com. | Plasma | 450 | 30 | N₂:H₂ = 1:1 | 4 |
| Ex. 11 | Nitriding | | | | |

TABLE 6

| | | | | Gas | |
|---|---|---|---|---|---|
| | | | | Mixing | |
| | Nitriding | | Time | Ratio | Pressure |
| | Method | Temp.(C. °) | (minute) | (N₂:H₂) | (Torr) |
| Ex. 23 | Plasma | 500 | 10 | 1:1 | 4 |
| | Nitriding | | | | |
| Ex. 24 | Plasma | 450 | 10 | 3:7 | 7 |
| | Nitriding | | | | |
| Ex. 25 | Plasma | 400 | 10 | 7:3 | 3 |
| | Nitriding | | | | |
| Com. Ex. 12 | None | — | — | — | — |
| Com. Ex. 13 | Plasma | 550 | 10 | 1:1 | 4 |
| | Nitriding | | | | |

Each sample was evaluated in the following method.

(Identification of Crystal Structure of Nitride Layer)

Crystal structures of nitride layers of the samples obtained by the aforementioned methods were identified by X-ray diffraction measurement of the base material surfaces modified by nitriding. X-ray diffraction device (XRD) made by Mac Science Co., Ltd. was used as a measurement device. Measurements were performed under conditions where a radiation source was CuKα ray, a diffraction angles was between 2 and 100 degrees, and a scan speed was 2 degrees/min.

(Thickness Measurement of Nitride Layer)

Thicknesses of nitride layers were measured by observation of cross sections thereof by using an optical microscope or a scanning electron microscope.

(Measurement of Atom Ratio of Cr to Fe and Measurement of Nitrogen Content and Oxygen Content)

Measurement of the atom ratio of Cr to Fe contained in each nitride layer was obtained by measuring Fe content and Cr content in each nitride layer using an X-ray photoelectron spectroscopy (XPS). The nitrogen content and oxygen content at the depth of 3 to 4 nm from the outermost surface of the nitride layer were measured using XPS, and the ratio of oxygen content to nitrogen content O/N was obtained from the measurement results of the contents. The photoelectron spectroscopy device Quantum-2000 made by ULVAC-PHI, Inc. was used as a measurement device. The measurement was carried out by illuminating the samples with X-rays with the radiation source of Monochromated-Al-Kα ray (1486.4 eV, 20.0 W), a photoelectron extraction angle of 45 degrees, a measuring depth of about 4 nm, and a measuring area of φ 200 μm.

(Measurement of Nitrogen Contents and Oxygen Contents at Depths of 10 nm and 100 nm from Outermost Layer of Nitride Layer)

Nitrogen contents and oxygen contents at the depths of 10 nm and 100 nm from the outermost of each nitride layer were measured by using scanning Auger electron spectrometry equipment. The measurement device used was MODEL4300 made by ULVAC-PHI, Inc. The measurement was carried out under the following conditions: an electron beam acceleration voltage of 5 kV, a measuring region of 20 μm×16 μm, an ion gun accelerating voltage of 3 kV, and a sputtering rate of 10 nm/min (SiO₂ converted value).

(Measurement of Contact Resistance Values)

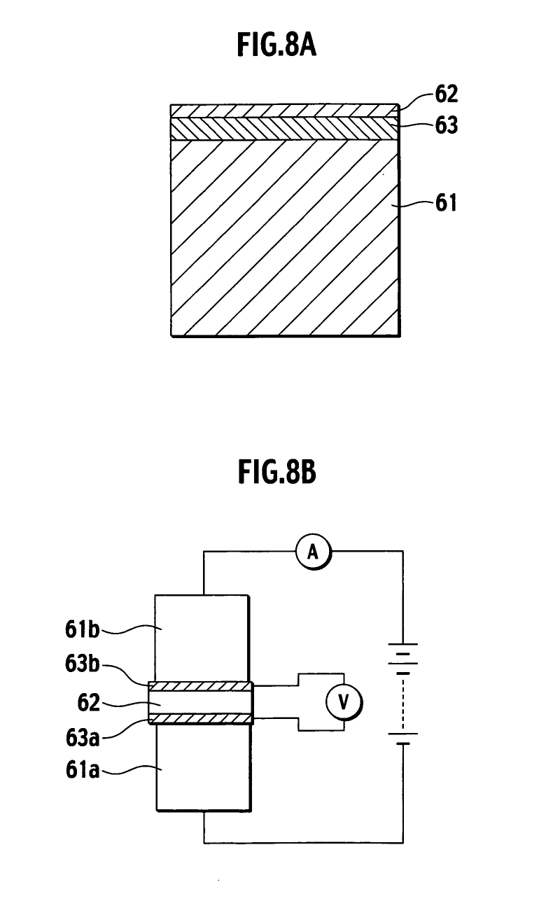

A piece having a size of 30 mm×30 mm was cut out from each sample obtained from the foregoing Examples 1 to 14 and Comparative Examples 1 to 7 and contact resistance was measured. A TRS-2000SS type contact resistance measuring device made by ULVAC-RIKO, Inc. was used as a measuring device. As shown in FIG. 8A, carbon paper 63 was placed between the electrode 61 and a sample 62, so that, as shown in FIG. 8B, a construction of an electrode 61a/carbon paper 63a/sample 62/carbon paper 63b/and electrode 61b was made. Then, electrical resistance was measured twice when a current of 1 A/cm² at pressure on a measuring surface of 1.0 MPa was applied to the construction, and an average value of the measurements was obtained. The carbon papers used were those on which platinum-loaded carbon black was applied (carbon paper TGP-H-090 made by Toray Industries Inc., with a thickness of 0.26 mm, an apparent density of 0.49 g/cm³, a void volume of 73%, air permeability of 37 mmaq/mm, and thickness volume resistivity of 0.07 Ω·cm²). The electrodes used were Cu-made electrodes φ 20 mm. Note that, in the Example 15-25, and Comparative Example 8-13, the electrical resistance was measured twice before and after electrolysis testing.

<Evaluation of Corrosion Resistance>

In a fuel cell, electric potential applied to an oxygen electrode side is up to about 1 V vs SHE in comparison with a hydrogen electrode side. In addition, a polymer electrolyte membrane, having a proton exchange group such as a sulfonic acid group within a molecule, exerts proton conductivity when saturated with water, and exhibits strong acidity. Therefore, corrosion resistance was evaluated by constant-potential electrolysis testing, that is an electrochemical method, where sample pieces are held in an acidic solution for a certain period of time while applying predetermined constant electric potential, and then amounts of metal ion dissolved in the solution were measured by fluorescent X-ray analysis. Based upon values of amounts of ion elusion, degrees of resistance deterioration were evaluated.

More specifically, a sample piece was cut out from the center of each sample and had a size of 30 mm×30 mm. These pieces were then held for 100 hours in a sulfuric acid aqueous solution of pH 2, at temperature of 80 degrees centigrade, and at electric potential of 1 V vs SHE. Thereafter, amounts of Fe, Cr and Ni ion elusion within the sulfuric acid aqueous solution were measured by fluorescent X-ray analysis.

### EXAMPLES 1 TO 14 AND COMPARATIVE EXAMPLES 1 TO 7

Table 7 shows crystal structures and thicknesses of nitride layers, atom ratios of Cr to Fe (Cr/Fe), contact resistance values, and amounts of ion elution of Examples 1 to 14 and Comparative Examples 1 to 7.

TABLE 7

| | Main Crystal | Nitride | Atom Ratio of | | Contact | | | |
|---|---|---|---|---|---|---|---|---|
| | Structure of | Layer | Cr to Fe | | Resistance | | | |
| | Sample | Thickness | Nitride | Base | Value | Ion Elusion (mg/L) | | |
| | Surface | (μm) | Layer | Material | (mΩ · cm²) | Fe | Cr | Ni |
| Ex. 1 | M₄N + γ | 1.2 | 14.6 | 28.5 | 5 | 0.6 | 0.02 | 0.07 |
| Ex. 2 | M₄N + γ | 1.5 | 15.2 | 27.8 | 2 | 0.4 | 0.01 | 0.08 |
| Ex. 3 | M₄N + γ | 1.8 | 15.8 | 28.6 | 7 | 0.6 | 0.02 | 0.08 |
| Ex. 4 | M₄N + γ | 9.5 | 21.8 | 48.5 | 6 | 0.8 | 0.03 | 0.09 |
| Ex. 5 | M₄N + γ | 5.5 | 19.1 | 28.5 | 3 | 0.9 | 0.08 | 0.12 |
| Ex. 6 | M₄N + γ | 1.3 | 17.3 | 38.6 | 4 | 0.7 | 0.03 | 0.09 |
| Ex. 7 | M₄N + γ | 0.5 | 15.5 | 27.8 | 9 | 0.5 | 0.02 | 0.07 |
| Ex. 8 | M₄N + γ | 0.9 | 16.2 | 28.2 | 8 | 0.5 | 0.01 | 0.08 |
| Ex. 9 | M₄N + γ | 0.03 | 16.1 | 28.5 | 7 | 2.1 | 0.38 | 0.58 |
| Ex. 10 | M₄N | 12.5 | 22.1 | 28.7 | 6 | 2.6 | 0.57 | 0.62 |
| Ex. 11 | M₄N + CrN | 11.5 | 23.5 | 28.3 | 10 | 3.8 | 0.98 | 0.97 |
| Ex. 12 | M₄N + CrN | 7.8 | 51.4 | 27.9 | 13 | 8.7 | 1.75 | 2.58 |
| Ex. 13 | M₄N + CrN | 12.1 | 65.3 | 28.4 | 20 | 12.8 | 3.2 | 4.3 |
| Ex. 14 | M₄N + CrN | 14.8 | 77.1 | 28 | 40 | 9.8 | 2.1 | 3.3 |
| Com. Ex. 1 | γ | — | — | 28.5 | 2019 | 6.8 | 1.90 | 1.30 |
| Com. Ex. 2 | γ | — | — | 27.6 | 765 | 5.4 | 1.20 | 1.00 |
| Com. Ex. 3 | γ | — | — | 38.5 | 245 | 4.7 | 1.01 | 0.86 |
| Com. Ex. 4 | γ′ + CrN | 5.2 | 46.2 | 28.6 | 9 | 8.9 | 1.80 | 2.70 |
| Com. Ex. 5 | γ′ + CrN | 8.5 | 61.2 | 29.1 | 7 | 14.5 | 3.50 | 4.60 |
| Com. Ex. 6 | γ′ + CrN | 12.3 | 75.4 | 28.8 | 8 | 10.2 | 2.30 | 3.50 |
| Com. Ex. 7 | γ | 0.01 | 28.4 | 28.1 | 100 | 6.3 | 1.7 | 1.2 |

Table 8 shows nitrogen and oxygen contents on top surfaces of nitrogen layers, ratios of oxygen content to nitrogen content O/N, and nitrogen and oxygen contents at the depths of 10 nm and 100 nm from the outermost layers of nitride layers of Examples 1 to 14 and Comparative Examples 1 to 7.

TABLE 8

| | X-Ray Photoelectron | | | Scanning Auger | | | |
|---|---|---|---|---|---|---|---|
| | Spectroscopy | | | Electron Spectrometry | | | |
| | N and O | | | N and O | | N and O | |
| | Contents on | | | Contents at | | Contents at | |
| | Top Surface | | O/N | 10 nm Depth | | 100 nm Depth | |
| | (atom %) | | Ratio on | (atom %) | | (atom %) | |
| | N | O | Top Surface | N | O | N | O |
| Ex. 1 | 14 | 26 | 1.9 | 20 | 18 | 17 | 13 |
| Ex. 2 | 19 | 18 | 1.0 | 23 | 15 | 20 | 9 |
| Ex. 3 | 13 | 35 | 2.8 | 18 | 21 | 15 | 15 |
| Ex. 4 | 13 | 30 | 2.2 | 18 | 19 | 16 | 15 |
| Ex. 5 | 16 | 24 | 1.5 | 22 | 16 | 19 | 11 |
| Ex. 6 | 15 | 26 | 1.7 | 21 | 17 | 18 | 12 |
| Ex. 7 | 11 | 35 | 3.2 | 17 | 22 | 15 | 16 |
| Ex. 8 | 12 | 32 | 2.7 | 19 | 22 | 16 | 15 |
| Ex. 9 | 13 | 34 | 2.6 | 18 | 21 | 15 | 16 |
| Ex. 10 | 13 | 29 | 2.2 | 19 | 19 | 16 | 15 |
| Ex. 11 | 10 | 35 | 3.5 | 18 | 22 | 17 | 17 |
| Ex. 12 | 12 | 37 | 3.1 | 18 | 22 | 17 | 17 |
| Ex. 13 | 10 | 40 | 4.0 | 17 | 23 | 16 | 18 |
| Ex. 14 | 9 | 43 | 4.8 | 15 | 26 | 16 | 21 |
| Com. Ex. 1 | 0.3 | 69 | 230.0 | 4 | 45 | 8 | 38 |
| Com. Ex. 2 | 0.9 | 64 | 71.1 | 6 | 38 | 10 | 35 |
| Com. Ex. 3 | 2.2 | 58 | 26.4 | 9 | 32 | 12 | 29 |
| Com. Ex. 4 | 11 | 34 | 3.2 | 16 | 22 | 16 | 16 |
| Com. Ex. 5 | 13 | 33 | 2.5 | 19 | 20 | 15 | 14 |
| Com. Ex. 6 | 12 | 35 | 2.9 | 18 | 22 | 15 | 15 |
| Com. Ex. 7 | 7.2 | 50 | 6.9 | 12 | 30 | 15 | 25 |

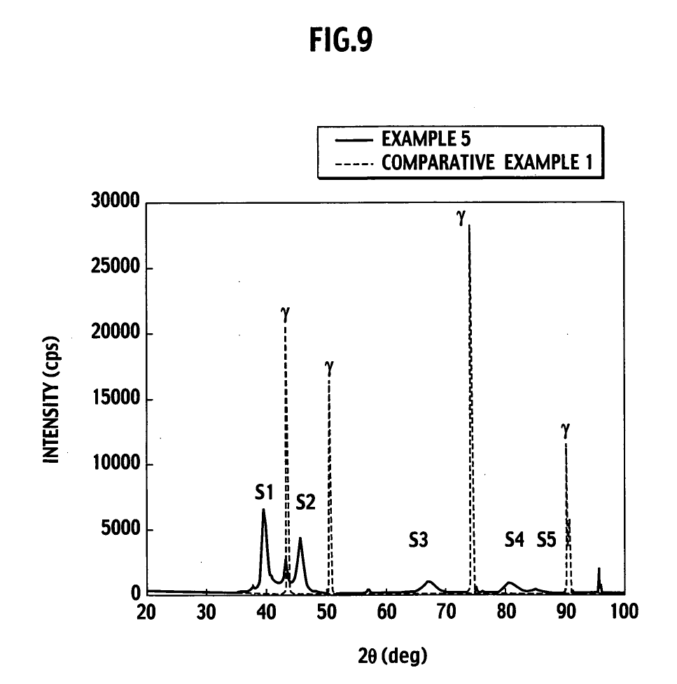

Further, FIG. 9 shows X-ray diffraction patterns of the samples obtained from the foregoing Example 5 and Comparative Example 1.

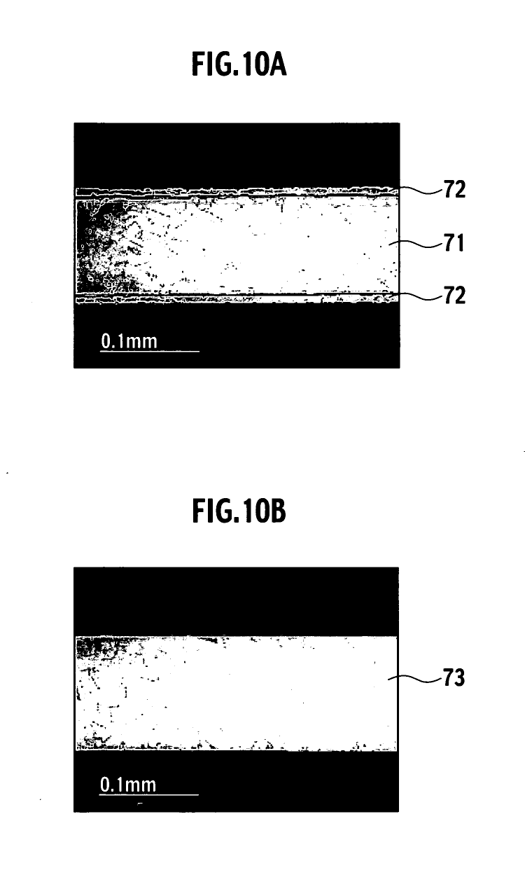

In Comparative Example 1, only peaks derived from austenite of the base material were clearly observed. Meanwhile, in Example 5, not only peaks derived from austenite (γ in FIG. 9), the base material, but also peaks S1 to S5 indicating the foregoing M₄N-type crystal structure were observed. Here, M is mainly Fe and includes an alloy with Cr, Ni or Mo other than Fe. The thickness of each nitride layer was observed in the cross-sectional view shown in FIG. 10A, and, in Example 5, about 5.5 μm-thick nitride layers were observed on the surfaces. As evident from above, despite the fact that the surface of the sample is covered with the nitride layer having the M₄ N-type crystal structure, X-ray diffraction peaks derived from austenite of the base material were also observed. The determined reason was that an incident depth of an X-ray into the base material was about 10 μm under the measurement conditions and therefore the base material was detected. In Examples 1 to 4 and 6 to 10, not only peaks derived from austenite of the base material, but also those of the aforementioned M₄N-type crystal structure were observed similarly to Example 5.

In Examples 11 to 14, peaks of CrN were observed in addition to the peaks S1 to S5 indicating M₄N-type crystal structure. This proved that nitriding temperature exceeding 500° C. and nitriding time exceeding 10 minutes resulted in deposition of Cr-based nitride compound having the NaCl-type crystal structure such as CrN, other than the M₄N-type crystal structure.

Further, in the samples of Comparative Example 2 and 3, only the peaks derived from austenite of the base material were observed since no nitride layers were formed similarly to Comparative Example 1. Furthermore, in Comparative Example 7, only the peaks derived from austenite of the base material were observed. It can be considered that no nitride layer was formed in Comparative Example 7 because nitriding temperature was as low as 350° C., and nitriding time was short.

In Comparative Examples 4 to 6, peaks indicating CrN and γ′ phases were observed. The γ′ phase had a crystal structure where an N atom is interstitially present in the octahedral gap at the center of the unit cell of a face-centered cubic lattice formed of Fe atoms, in other words, an Fe₄N-type crystal structure where an N atom is located in ¼ of the octahedral gap. This Fe₄N-type crystal structure did not contain alloys of Cr and Ni other than Fe. Therefore, once the γ′ phase was generated, Cr-based nitride compound having the NaCl-type crystal structure such as CrN was formed at the same time. It was thus considered that corrosion resistance of the base material was lowered, and an elution amount of Cr ion was increased. This proved that nitriding temperature exceeding 500° C. resulted in deposition of Cr-based nitride compound having the NaCl-type crystal structure such as CrN.

In FIG. 1A, the nitride layers 72 were formed on both surfaces of the base material 71. However, FIG. 10B shows that no modified layer such as a nitride layer was formed on the surface of the base material 73.

Further, as shown in Table 8, in Examples 1 to 14 where the nitride layers having the M₄N-type crystal structure were formed, contact resistance values were 40 mΩ·cm² or lower. On the contrary, in Comparative Examples 1 to 3 and 7 where no nitride layers were formed, contact resistance values were remarkably high. In a fuel cell, a theoretical voltage per single cell is 1.23 V, but a voltage which can be actually extracted is reduced due to reaction polarization, gas diffusion polarization and resistance polarization, and the larger a current to be extracted is, the lower the voltage becomes. Moreover, as higher power density per unit volume and weight is demanded, a fuel cell for a vehicle use is used at a high current density, for example, a current density of 1 A/cm², in comparison with a stationary type fuel cell. It is considered that, when the current density is 1 A/cm², an efficiency decrease due to contact resistance between a separator and a carbon paper can be suppressed if the contact resistance is 20 mΩ·cm², in other words, if a measurement value obtained by the measurement method of FIG. 8B is 40 mΩ·cm² or lower. In Examples 1 to 14, contact resistance values were 40 mΩ·cm² or lower, so an electromotive force per single cell is high, enabling a fuel cell stack with high electromotive force to be formed.

Next, according to the measurement results of ion elution amounts, it was found that Examples 1 to 8, where the thicknesses of the nitride layers were between 0.5 and 10 μm, had low ion elution amounts, so they had excellent corrosion resistance. In Example 9, since the thickness of the nitride layer was 0.03 μm, the contact resistance was low, but the ion elution amount was slightly more than those of Examples 1 to 8. This resulted in the corrosion resistance which was slightly inferior to that of Examples 1 to 8.

In Example 10, since the thickness of the nitride layer was over 10 μm, pitting corrosion easily occurred and the contact resistance value was thus low. The ion elution amount was also slightly more than those of Examples 1 to 8, and corrosion resistance was inferior to that of Examples 1 to 8. In Examples 11 to 14, Cr-based nitride compound having the NaCl-type crystal structure such as CrN was deposited in addition to compound having the M₄N-type crystal structure. Therefore, the contact resistance value and ion elution amount were higher than those of Examples 1 to 10.

Where a surface of austenitic stainless steel is not nitrated like Comparative Examples 1 to 3, contact resistance thereof becomes higher than that of Examples 1 to 10, because a passive state film is formed on the surface. Although austenitic stainless steel generally has excellent corrosion resistance because of the passive state film, corrosion resistance of Examples 1 to 3 was found to be inferior to that of Examples 1 to 8.

Like in Comparative Examples 4 to 6, where nitriding is performed but a nitride layer mainly contains CrN having the NaCl-type crystal construction, contact resistance becomes lower than that of Comparative Examples 1 to 3 where no nitriding was performed. However, corrosion resistance thereof becomes inferior to Comparative Examples 1 to 3.

Now we focus on nitrogen content and oxygen content measured by XPS at the depth of 3 to 4 nm from the outermost surface of the nitride layer, as well as the ratio of the oxygen content to the nitrogen content O/N shown in Table 8. In Examples 1 to 14, the nitrogen content and oxygen content were 9 atom % or higher and 43 atom % or lower, respectively, at the depth of 3 to 4 nm from the outermost surface of the nitride layer, and values of O/N were 4.8 or lower. In Examples 1 to 14, the contact resistance values were all 40 mΩ·cm² or lower. On the other hand, where the surface of austenitic stainless steel was not nitrided like in Comparative Examples 1 to 3, or where no nitride layer was formed like Comparative Example 7, passive state films were present on the surfaces of the base materials. Therefore, the oxygen contents at the depth of 3 to 4 nm from the outermost surface of these Comparative Examples were high, and the values of O/N were also very large. In Comparative Examples 4 to 6, since Cr-based nitride such as CrN was mainly deposited, the contact resistance was low and the values of O/N were small. However, the ion elution amounts were large and the corrosion resistance was thus deteriorated.

FIG. 11 shows an element profile in the depth direction obtained from the sample of Example 5 by scanning Auger electron spectrometry. As shown in FIG. 11, on the outermost surface of the nitride layer, there was an oxide film because of a small oxygen partial pressure present during nitriding, and electrons can freely move in the thickness direction of the oxide film. Thus, the highest oxide content can be seen on the outermost surface. However, since electrons can freely move only in the area between the outermost surface and the depth of 3 to 4 nm, the oxygen content was gradually reduced and the nitrogen content was increased. Further, at the depth of 10 nm from the outermost surface of the nitride layer, the nitrogen content was 33 atom % and the oxygen content was 16 atom %. At the depth of 100 nm, the nitrogen content was 19 atom % and the oxygen content was 5 atom %. The ratio of Fe, a component of the base material, started increasing from about the sputtering depth of 50 nm. The contact resistance value at this point was 30 mΩ cm², and the ion elution amount was also low. This shows that Example 5, where the nitride layer having the M₄N-type crystal structure was formed, had satisfactory levels of contact resistance and corrosion resistance.

Similarly, in any of Examples 1 to 4 and 6 to 10 where contact resistance values were 40 mΩ·cm² or lower, the nitride content and the oxygen content at the depth of 10 nm from the outermost surface of the nitride layer were 15 atom % or higher and 26 atom % or lower, respectively, and the nitride content and the oxygen content at the depth of 100 nm from the outermost surface of the nitride layer were 16 atom % or higher and 21 atom % or lower, respectively. On the contrary, in Comparative Examples 1 to 3 where the contact resistance values exceed 10, the nitride content and the oxygen content at the depth of 10 nm from the outermost surface of the nitride layer deviated from the above-mentioned values, and the same at the depth of 100 nm from the outermost surface of the nitride layer also deviated from the above values. In Comparative Examples 4 to 6 where no passive state films were formed, the foregoing values were satisfied.

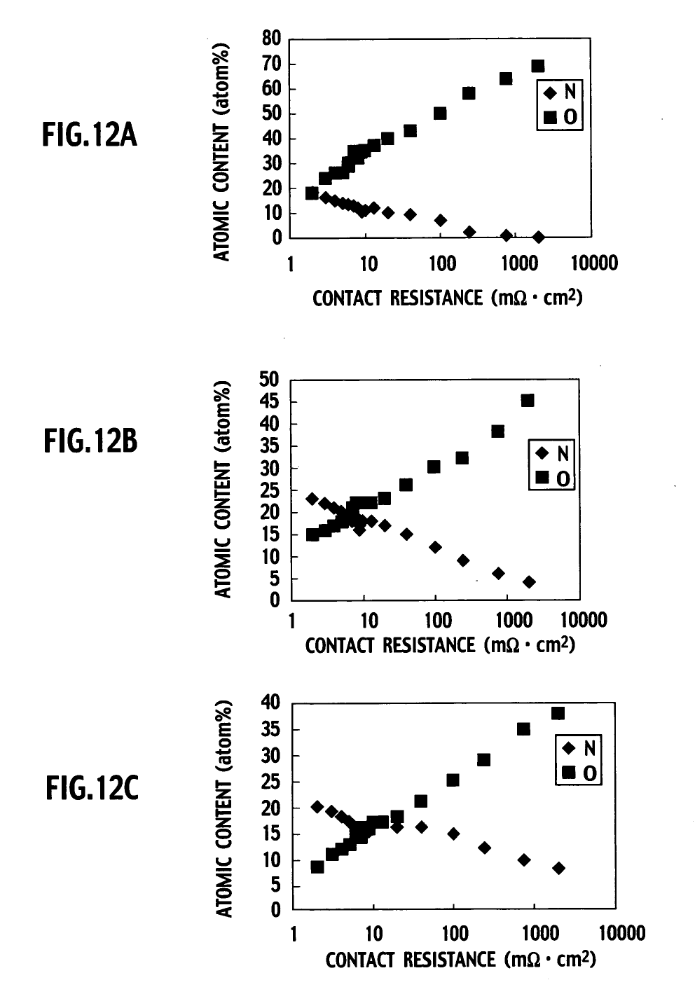

FIGS. 12A to 12C show relationships between nitrogen and oxygen contents and a contact resistance value. FIG. 12A shows a relationship between a contact resistance value and nitrogen and oxygen contents at the depth of 3 to 4 nm from the outermost surface of the nitride layer. FIG. 12B shows a relationship between a contact resistance value and nitrogen and oxygen contents at the depth of 10 nm from the outermost surface. FIG. 12C shows a relationship between a contact resistance value and nitrogen and oxygen contents at the depth of 100 nm from the outermost surface.

As shown in FIG. 12A, the nitrogen content and oxygen content at the depth of 3 to 0.4 nm from the outermost surface of the nitride layer have a good relative relationship with a contact resistance value. It was found that the more the nitrogen content, the smaller the contact resistance value becomes, and the less the oxygen content, the smaller the contact resistance value becomes. The reason of this is considered that, as stated earlier, where the oxygen content in a nitride layer is large, an insulating oxide film is formed on the surface of the base material and a contact resistance value becomes thus high, and, where a nitride layer is formed on the surface of the base material, the oxide film is prevented from glowing, and therefore contact resistance value becomes low.

Similarly, as shown in FIG. 12B, the nitrogen content and oxygen content at the depth of 10 nm from the outermost surface of the nitride layer have a good relative relationship with a contact resistance value. Further, as shown in FIG. 12C, the nitrogen content and oxygen content at the depth of 100 nm from the outermost surface of the nitride layer have a good relative relationship with a contact resistance value. It was thus found that the more the nitrogen content, the smaller the contact resistance value becomes, the lower the oxygen content, the smaller the contact resistance value becomes.

According to the measurement results above, any of the Examples 1 to 14 has a nitride layer having a crystal structure where an N atom is located in the octahedral gap at the center of the unit cell of a face-centered cubic lattice formed of at least one or more kinds of metal atoms selected from the group of Fe, Cr, Ni and Mo. Therefore, in comparison with Comparative Examples 1 to 7, any of Examples 1 to 14 shows a low contact resistance value of 40 mΩ·cm² or lower, and also has small ion elution amount and excellent corrosion resistance. This means that Examples 1 to 14 have both low contact resistance and high corrosion resistance.

Note that, in Examples, austenitic stainless steel was used as the base material. However, the base material is not limited to it. Similar effects can be achieved with ferritic or martensitic stainless steel. Ion nitriding was applied for the nitriding, but similar effects can be achieved by gas nitriding.

### EXAMPLES 15 TO 22 AND COMPARATIVE EXAMPLES 8 TO 11

Next, Table 9 shows crystal structures and contact resistance values of samples before and after electrolysis testing in Examples 15 to 22 and Comparative Examples 8 to 11.

TABLE 9

| | | Contact Resistance Value | |
|---|---|---|---|
| | | (mΩ · cm²) | |
| | | Before | After |
| | Main Crystal Structure of | Electrolysis | Electrolysis |
| | Sample Surface | Testing | Testing |
| Ex. 15 | Cubic Crystal Compound (M₄N) | 9.8 | 10.5 |
| Ex. 16 | Cubic Crystal Compound (M₄N) | 4.6 | 5.4 |
| Ex. 17 | Cubic Crystal Compound | 4.3 | 5.1 |
| | (M₄N + CrN) | | |
| Ex. 18 | Cubic Crystal Compound (CrN) | 4.9 | 12.7 |
| Ex. 19 | Cubic Crystal Compound (M₄N) | 8.6 | 9.2 |
| Ex. 20 | Cubic Crystal Compound | 5.2 | 6.5 |
| | (M₄N + CrN) | | |
| Ex. 21 | Cubic Crystal Compound (M₄N) | 4.8 | 5.5 |
| Ex. 22 | Cubic Crystal Compound (TiN) | 5.4 | 6.7 |
| Com. | Cubic Crystal Alloy (γ) | 765 | 2919 |
| Ex. 8 | | | |
| Com. | Cubic Crystal Alloy (γ) | 306 | 1158 |
| Ex. 9 | | | |
| Com. | Close-Packed Hexagonal | 329 | 1778 |
| Ex. 10 | Crystal Metal (α-Ti) | | |
| Com. | Wurtzite Structure Compound | 3567 | 4568 |
| Ex. 11 | (AIN) | | |

Table 10 shows nitrogen and oxygen contents on top surfaces of nitride layers, ratios of oxygen content to nitrogen content O/N, and nitrogen and oxygen contents at the depths of 10 nm and 100 nm from the outermost layers of nitride layers obtained in Examples 15 to 22 and Comparative Examples 8 to 11.

TABLE 10

| | X-Ray Photoelectron | | | Scanning Auger | | | |
|---|---|---|---|---|---|---|---|
| | Spectroscopy | | | Electron Spectrometry | | | |
| | N and O | | | N and O | | N and O | |
| | Contents on | | | Contents at | | Contents at | |
| | Top Surface | | O/N | 10 nm Depth | | 100 nm Depth | |
| | (atom %) | | Ratio on | (atom %) | | (atom %) | |
| | N | O | Top Surface | N | O | N | O |
| Ex. 15 | 5.1 | 23 | 4.5 | 20 | 23 | 18 | 3 |
| Ex. 16 | 5.9 | 31 | 5.3 | 18 | 18 | 23 | 2 |
| Ex. 17 | 6.9 | 40 | 5.8 | 20 | 7 | 23 | 18 |
| Ex. 18 | 5.4 | 30 | 5.6 | 13 | 27 | 25 | 12 |
| Ex. 19 | 5.1 | 36 | 7.1 | 17 | 12 | 16 | 5 |
| Ex. 20 | 5.7 | 30 | 5.3 | 12 | 18 | 20 | 10 |
| Ex. 21 | 5.6 | 23 | 4.1 | 16 | 23 | 18 | 11 |
| Ex. 22 | 8.8 | 22 | 2.5 | 30 | 30 | 40 | 20 |
| Com. Ex. 8 | 1.8 | 54 | 30.0 | 8 | 42 | 13 | 25 |
| Com. Ex. 9 | 2.2 | 52 | 23.6 | 5 | 34 | 5 | 21 |
| Com. Ex. 10 | 4.2 | 51 | 12.1 | 0 | 45 | 0 | 30 |
| Com. Ex. 11 | 3.9 | 59 | 15 | 3 | 52 | 0 | 28 |

In the X-ray diffraction pattern of the sample obtained in Comparative Example 8, a peak derived from austenite of the base material was clearly observed. Meanwhile, in Examples 15, 16, 19 and 21, peaks derived from M₄N having a cubic crystal structure were observed in addition to peaks derived from austenite. In Examples 17 and 20, peaks derived from M₄N having a cubic crystal structure and CrN were observed in addition to peaks derived from austenite of the base material. In Example 18, a peak derived from CrN was observed in addition to a peak derived from austenite of the base material. In Example 22, a peak of TiN was observed. In Comparative Example 9, a peak derived from austenite of the base material was observed, and, in Comparative Example 10, a peak of alpha-phase titanium, the base material was observed. In Comparative Example 11, a peak of aluminum nitride (AlN) was observed in addition to a peak of aluminum having a crystal structure of fcc, the base material.

As shown in Table 10, in Examples 15 to 22 where nitride layers having cubic crystal structures were formed, a nitride compound such as M₄N, CrN, and TiN having cubic crystal structures was formed on the surface of the base material. Therefore, contact resistance values thereof before electrolysis testing were 10 MΩ·cm² or lower. On the other hand, contact resistance values were high in Comparative Examples 8 to 10 as no nitride layer was formed and an insulating passive state film was formed on the surface of the base material. Further, in Comparative Example 11 where plasma nitriding was performed on aluminum, which is not transition metal, the nitride layer thus obtained did not become a compound having a cubic crystal structure but a Wurtzite structure compound (AlN) where two close-packed hexagonal crystal structures were combined. Therefore, the sample piece did not have conductivity and contact resistance thereof was high. Since the band gap of aluminum nitride of the Wurtzite structure compound was as large as about 6.3 eV, it is an insulator and therefore seems very unlikely to become a conductor.

In a fuel cell, it is considered that if values of contact resistance measured by the apparatus shown in FIG. 8 are 40 mΩ cm² or lower, efficiency reduction due to contact resistance is prevented. Since values of contact resistance in Examples 15 to 22 were 40 mΩ·cm² or lower, a fuel cell stack with high electromotive force can be fabricated.

According to measurement results of contact resistance after electrolysis testing, values of contact resistance rose after electrolysis testing in Examples 15 to 22 but only to around 10 mΩ·cm². The values of contact resistance could be maintained low even after the electrolysis testing. This is because nitride layers having cubic crystal structures were formed on the surfaces of the base materials, and therefore, transition metal atoms were chemically stabilized and the sample pieces were not easily oxidized. In other words, by increasing chemical potential of nitrogen atoms within the nitride layers and keeping low activity of transition metal atoms in the base materials, reactivity of transition metal atoms within the nitride layers to oxidation was reduced. Therefore, it is considered that they were still excellent in corrosion resistant even after the electrolysis testing. Furthermore, nitride layers were rich in nitrogen atoms in the area between the outermost surface thereof and the depth of a few to a few tens of nm. Therefore, values of contact resistance between the surface of base material and a gas diffusion layer can be maintained low. Meanwhile, in Comparative Examples 8 to 11, since nitrogen contents on the surfaces of the base materials were small, transition metal atoms were easily oxidized and insulating passive state films were formed on the surfaces of the base materials easily. This is why values of contact resistance after electrolysis testing increased so much.

As described so far, Comparative Examples 8 to 10 where no nitriding was performed on the surfaces of base materials, showed higher contact resistance than those in Examples 15 to 22 because of passive state films formed on the surfaces of the base materials. Moreover, as in Comparative Example 11, if the base material is not made of transition metal, a nitride layer having a cubic crystal structure is not formed and a contact resistant value becomes large even if nitriding is performed.

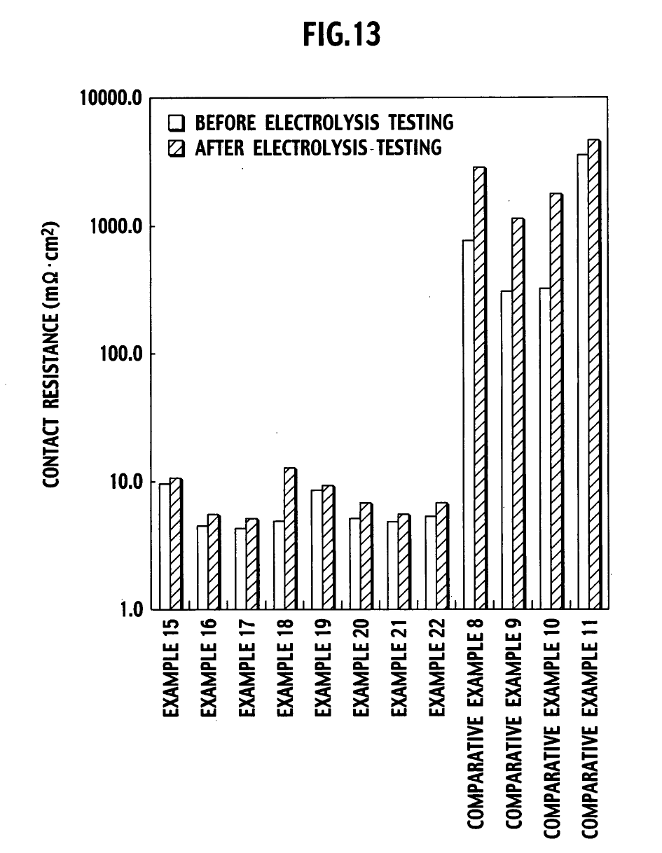

As for nitrogen and oxygen contents and ratios of oxygen content to nitrogen content O/N on the top surfaces of nitride layers measured by XPS in Table 10, Examples 15 to 22 had nitrogen contents of 5 atom % or higher and oxygen contents of 50 atom % or lower, as well as O/N of 10.0 or lower on the top surfaces of nitride layers, and the values of contact resistance before the electrolysis testing were 10 mΩ·cm² or lower. On the other hand, Comparative Examples 8 to 10 in which no nitriding of the surfaces of the base materials was performed had high oxygen content on the top surfaces because of passive state films formed on the surfaces of the base materials, and O/N values were also high. Further, in Comparative Example 11 in which the base material was not made of transition metal, the O/N value was higher than 10.0 even though nitriding was performed. FIG. 13 shows values of contact resistance of samples obtained in Examples 15 to 22 and Comparative Examples of 8 to 11 before and after the electrolysis testing. In comparison with Comparative Examples 8 to 11, contact resistance values of Examples 15 to 22 were as low as 10 mΩ·cm² or lower before the electrolysis testing and were still low after the electrolysis testing.

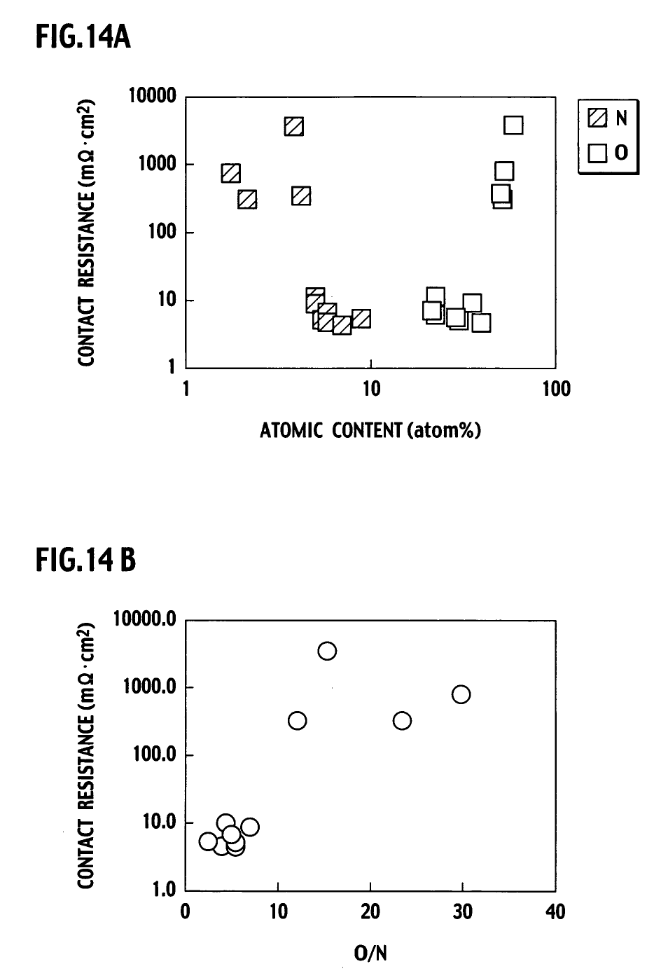

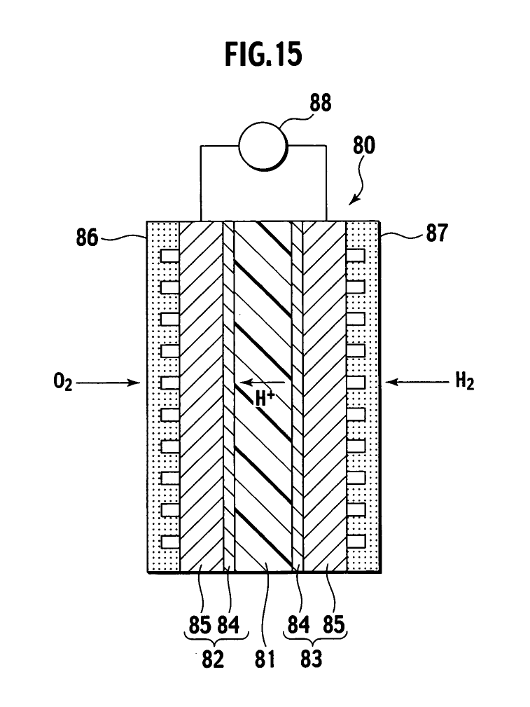

FIGS. 14A and 14B show relationships between a contact resistance value and nitrogen and oxygen contents. FIG. 14A shows a relationship between a contact resistance value and nitrogen and oxygen contents on the top surface. FIG. 14B shows a relationship between a contact resistance value and a ratio of oxygen content to nitrogen content O/N on the top surface. As shown in FIG. 14A, it became evident that the higher the nitrogen content on the top surface is, the lower contact resistance becomes, and the lower the oxygen content is, the lower contact resistance becomes. This is because, as described earlier, with high oxygen content within a nitride layer, an insulating oxide film is formed on the surface of a base material, thus increasing a contact resistance value. Where a nitride layer is formed on the surface of a base material, an oxide film is prevented from growing, thus lowering a contact resistance value. Similarly, as shown in FIG. 14B, it became evident that the lower a ratio of oxygen content to nitrogen content on the top surface is, the lower a contact resistance value becomes.

According to the results of scanning Auger electron spectrometry, the sample obtained in Example 17 had an oxide film because some oxygen partial pressure was present on the outermost surface of the nitride layer during nitriding. Nevertheless, the thickness of the oxide film is as small as about 3 to 4 nm through which electrons can still move freely, and the oxygen content was reduced gradually and nitrogen content increased. Moreover, nitrogen content and oxygen content at the depth of 10 nm from the outermost surface of the nitride layer were 22 atom % and 16 atom %, respectively. The nitrogen content and oxygen content at the depth of 100 nm from the outermost surface of the nitride layer were 19 atom % and 11 atom %. Note that the ratio of Fe, a component of the base material, started increase at the spatter depth of 50 nm. At this time, the value of contact resistance before the electrolysis testing was 4.3 mΩ·cm², and the same after the electrolysis testing was 5.1 mΩ·cm². Therefore, in Example 17 where a nitride layer having a cubic crystal structure was formed, had a low contact resistance value even after the electrolysis testing.

Similarly, in any of Examples 15, 16, and 18 to 22 with the values of contact resistance of 10 mΩ·cm² or lower, nitrogen content and oxygen content were 10 atom % or higher and 30 atom % or lower respectively at the depth of 10 nm from the outermost surface of the nitride layer, and those at the depth of 100 nm from the outermost surface of the nitride layer were 15 atom % or higher and 20 atom % or lower respectively. On the other hand, in Comparative Example 8 to 11 with the contact resistance values over 10, nitrogen content and oxygen contents at the depth of 10 nm from the outermost surface of the nitride layer varied from the abovementioned values, and nitrogen and oxygen contents at the depth of 100 nm from the outermost surface of the nitride layer also varied from the aforementioned values. It was thus suggested that nitrogen and oxygen contents at the depth of 10 nm or more from the outermost surface of a nitride layer have a close relationship with a contact resistance values before and after electrolysis testing.

### EXAMPLES 23 TO 25 AND COMPARATIVE EXAMPLES 12 AND 13

Table 11 shows crystal structures of nitride layers, states of metal atoms, states of metallic bonding, thicknesses of nitride layers and oxygen layers of the samples obtained in Examples 23 to 25 and Comparative Examples 12 and 13.

TABLE 11

| | Nitride Layer | | | | Oxide Layer |
|---|---|---|---|---|---|
| | Crystal | State of | | Thickness | Thickness |
| | Structure | Metal Atoms | State of Bonding | (μm) | (nm) |
| Ex. 23 | M₄N Type | No Regular | Metallic Bonding between | 2.0 | 5 |
| | | Arrangement | Metal Atoms | | |
| | | | Covalent Bonding between | | |
| | | | Metal and Nitrogen | | |
| Ex. 24 | M₄N Type | No Regular | Metallic Bonding between | 1.0 | 5 |
| | | Arrangement | Metal Atoms | | |
| | | | Covalent Bonding between | | |
| | | | Metal and Nitrogen | | |
| Ex. 25 | M₄N Type | No Regular | Metallic Bonding between | 0.5 | 3 |
| | | Arrangement | Metal Atoms | | |
| | | | Covalent Bonding between | | |
| | | | Metal and Nitrogen | | |
| Comp. | — | — | Metallic Bonding is Split by | — | 20 |
| Ex. 12 | | | Oxidation of Metal | | |
| Comp. | CrN | Regular | Metallic Bonding between | 6.0 | — |
| Ex. 13 | (Rock Salt | Arrangement | Metal Atoms | | |
| | Structure) | | Covalent Bonding between | | |
| | | | Metal and Nitrogen | | |

Table 12 shows nitrogen and oxygen contents and ratios of oxygen content to nitrogen content O/N on the top surfaces of nitride layers, and atom ratios of Cr to Fe of the samples obtained in Examples 23 to 25 and Comparative Examples of 12 and 13.

TABLE 12

| | N and O | | | | |
|---|---|---|---|---|---|
| | Contents on | | | Atom Ratios of | |
| | Top Surface | | | Cr to Fe | |
| | (atom %) | | O/N Ratios on | Nitride | Base |
| | N | O | Top Surface | Layer | Material |
| Ex. 22 | 15 | 25 | 1.7 | 0.22 | 0.27 |
| Ex. 23 | 10 | 22 | 2.2 | 0.19 | 0.27 |
| Ex. 24 | 12 | 20 | 1.7 | 0.14 | 0.27 |
| Comp. Ex. 12 | 42 | — | — | — | 27.6 |
| Comp. Ex. 13 | 15 | 33 | 2.2 | 75.4 | 28.8 |

Table 13 shows ion elution amounts and values of contact resistance of the samples before and after electrolysis testing in Examples 23 to 25 and Comparative Examples 12 and 13

TABLE 13

| | | | | Contact Resistance Value | |
|---|---|---|---|---|---|
| | | | | (mΩ · cm²) | |
| | | | | Before | After |
| | | | | Corrosion- | Corrosion- |
| | Ion Elution Amount (mg/L) | | | Resistance | Resistance |
| | Fe | Cr | Ni | Testing | Testing |
| Ex. 23 | 0.6 | 0.10 | 0.15 | 7 | 8 |
| Ex. 24 | 0.8 | 0.12 | 0.16 | 8 | 10 |
| Ex. 25 | 1.2 | 0.20 | 0.14 | 7 | 9 |
| Comp. Ex. 12 | 5.4 | 1.20 | 1.00 | 765 | 765 |
| Comp. Ex. 13 | 15.4 | 2.30 | 3.50 | 30 | 70 |

As shown in Tables. 11 to 13, in Comparative Example 12, no nitrogen layer was formed but an oxide film, a passive state film, was formed on the surface of the base material of the sample piece. Therefore, in comparison with Examples 23 to 25 in which nitride layers having the M₄N-type crystal structure were formed, an amount of metal ion elution in Comparative Example 12 was large and corrosion resistance was thus reduced. Further, since the oxide layer, a passive state film, was formed on the surface of the base material in Comparative Example 12, the contact resistance values before and after the corrosion resistance testing were high.

Further, in Comparative Example 13, a nitride layer was formed on the surface of the base material of the sample piece. However, the nitride layer was a CrN layer having the NaCl-type crystal structure with regular atom arrangement instead of having the M₄N-type crystal structure because of high nitriding temperature of 550 degrees centigrade. Moreover, contact resistance of the sample piece of Comparative Example 13 was low before the corrosion resistance testing but was high after the testing, resulting in low corrosion resistance. It is thought to be because Cr, an element that improves corrosion resistance contained in stainless steel, is concentrated in the nitride layer, and the density of Cr is thus reduced in the base material.

On the other hand, in the sample pieces of Examples 23 to 25, nitride layers had the M₄N-type crystal structure as shown in Table 11. Therefore, contact resistance values of these sample pieces both before and after the corrosion resistance testing were 10 mΩ·cm² or lower, and there was almost no change in contact resistance before and after the corrosion resistance testing. Each of the sample pieces had a small amount of ion elution and corrosion resistance was good. The reason why the sample pieces of Examples 23 to 25 had excellent electrochemical stability and high corrosion resistance under the oxidative environment is thought to be because the nitride layers had the M₄N-type crystal structure in which transition metal atoms and nitrogen atoms had strong covalent bonding therebetween while maintaining metallic bonding between transition metal atoms which construct the nitride layers. The other contribution to high corrosion resistance was that, since transition metal atoms, which construct M₄N-type face-centered cubic lattice, do not have regular arrangement, partial molar free energy of each transition metal component was reduced, resulting in low activity of each transition metal atoms.

The entire contents of Japanese Patent Applications No. P2004-069488 with a filing date of Mar. 11, 2004, P2004-260973 with a filing date of Sep. 8, 2004, P2004-283573 with a filing date of Sep. 29, 2004, P2004-293691 with a filing date of Sep. 29, 2004 and P2005-066065 with a filing date of Mar. 9, 2005 are herein incorporated by reference. Further, the entire content of co-pending U.S. patent application Ser. No. 11/071,286 with a filing date of Mar. 4, 2005 is herein incorporated by reference.

Although the invention has been described above by reference to certain embodiments of the invention, the invention is not limited to the embodiments described above will occur to these skilled in the art, in light of the teachings. The scope of the invention is defined with reference to the following claims.

What is claimed is:

1. A fuel cell separator, comprising:
a base material which comprises transition metal or an alloy of transition metal and has a path for fuel or an oxidant; and
a nitride layer which is provided from a surface of the base material towards an inside thereof, contacts a single cell of a fuel cell, and comprises a cubic crystal structure.

2. A fuel cell separator according to claim 1,
wherein an atom ratio of chromium to iron contained in the nitride layer is lower than that of chromium to iron contained in the base material.

3. A fuel cell separator according to claim 1,
wherein the base material comprises a stainless steel containing at least one kind of metallic element selected from the group consisting of iron, chromium, nickel and molybdenum.

4. A fuel cell separator according to claim 1,
wherein the cubic crystal structure is an M₄N-type crystal structure in which a nitrogen atom is located in an octahedral gap at a center of a unit cell of a face-centered cubic lattice formed of at least one kind of transition metal atom selected from the group consisting of iron, chromium, nickel and molybdenum.

5. A fuel cell separator according to claim 1,
wherein a thickness ratio of the nitride layer to the base material ranges from 1/2000 to 1/10.

6. A fuel cell separator according to claim 1,
wherein a thickness of the nitride layer ranges from 0.05 to 10 μm.

7. A fuel cell separator according to claim 1,
wherein an nitrogen content and an oxygen content at a depth of 3 to 4 nm from an outermost surface of the nitride layer are 5 atom % or higher and 50 atom % or lower, respectively.

8. A fuel cell separator according to claim 7,
wherein the nitrogen content and the oxygen content are 9 atom % or higher and 43 atom % or lower, respectively.

9. A fuel cell separator according to claim 8,
wherein the nitrogen content and the oxygen content are 10 atom % or higher and 35 atom % or lower, respectively.

10. A fuel cell separator according to claim 1,
wherein a ratio of an oxygen content to a nitrogen content at a depth of 3 to 4 nm from an outermost surface of the nitride layer is 10.0 or smaller.

11. A fuel cell separator according to claim 10,
wherein the ratio of the oxygen content to the nitrogen content is 4.8 or smaller.

12. A fuel cell separator according to claim 11,
wherein the ratio of the oxygen content to the nitrogen content is 3.5 or smaller.

13. A fuel cell separator according to claim 1,
wherein, at a depth of 10 nm from an outermost layer of the nitride layer, a nitrogen content is 10 atom % or higher and an oxygen content is 30 atom % or lower.

14. A fuel cell separator according to claim 13,
wherein the nitrogen content is 15 atom % or higher and the oxygen content is 26 atom % or lower.

15. A fuel cell separator according to claim 1,
wherein, at a depth of 100 nm from an outermost layer of the nitride layer, a nitrogen content is 16 atom % or higher and an oxygen content is 21 atom % or lower.

16. A fuel cell separator according to claim 1,
wherein the nitride layer has a density gradient of nitrogen from a surface of the nitride layer towards an inside thereof.

17. A fuel cell stack, comprising:
a fuel cell separator comprising: a base material which comprises transition metal or an alloy of transition metal and has a path for fuel or an oxidant; and a nitride layer which is provided from a surface of the base material towards an inside thereof, contacts a single cell of a fuel cell, and comprises a cubic crystal structure.

18. A fuel cell vehicle, comprising:
a fuel cell stack comprising a fuel cell separator comprising: a base material which comprises transition metal or an alloy of transition metal and has a path for fuel or an oxidant; and a nitride layer which is provided from a surface of the base material towards an inside thereof, contacts a single cell of a fuel cell, and comprises a cubic crystal structure.

19. A method of manufacturing a fuel cell separator, comprising:
preparing a base material which comprises transition metal or an alloy of transition metal and has a path for fuel or an oxidant; and
nitriding a surface of the base material at temperature of 590 degrees centigrade or lower to form a nitride layer having a M₄N-type crystal structure where a nitrogen atom is located in an octahedral gap at a center of a unit cell of a face-centered cubic lattice formed of at least one kind of metal atom selected from the group consisting of iron, chromium, nickel and molybdenum, on the surface of the base material.

20. A method of manufacturing a fuel cell separator according to claim 19,
wherein the nitriding is performed at temperature of 570° C. or lower.

21. A method of manufacturing a fuel cell separator according to claim 20,
wherein the nitriding is performed at temperature of 500° C. or lower.

22. A method of manufacturing a fuel cell separator according to claim 19,
wherein the nitriding is plasma nitriding.

23. A method of manufacturing a fuel cell separator according to claim 22,
wherein the plasma nitriding is performed by applying a negative bias voltage to the base material within low-temperature non-equilibrium plasma obtained by electric discharge of nitrogen gas and hydrogen gas.
